(19) United States
(12) Patent Application Publication
(10) Pub. No.: US 2024/0170201 A1
(43) Pub. Date: May 23, 2024

(54) MULTILAYER INDUCTOR COMPONENT

(71) Applicant: Murata Manufacturing Co., Ltd., Kyoto-fu (JP)

(72) Inventors: Shoto Kawamura, Nagaokakyo-shi (JP); Yuuichirou Yoshida, Nagaokakyo-shi (JP)

(73) Assignee: Murata Manufacturing Co., Ltd., Kyoto-fu (JP)

(21) Appl. No.: 18/516,218

(22) Filed: Nov. 21, 2023

(30) Foreign Application Priority Data
Nov. 21, 2022 (JP) 2022-185943

(51) Int. Cl. H01F 27/29; H01F 17/00; H01F 27/28

(52) U.S. Cl. CPC H01F 27/292; H01F 17/0013; H01F 27/2823; H01F 2017/0073

(57) ABSTRACT

A multilayer inductor component includes an element body and an inductor wire. The element body has a bottom surface, and a surface parallel to the bottom surface is a top surface. The inductor wire has inductor conductors extending parallel to the bottom surface and via conductors extending along an orthogonal axis orthogonal to the bottom surface. The area of each inductor conductor when viewed in the direction along the orthogonal axis is a conductor area, and the number of the inductor conductors is N. In the direction along the orthogonal axis, a top surface-side conductor area that is a sum of conductor areas of the inductor conductor closest to the top surface to the N/2th inductor conductor is 1.1 times or more of a bottom surface-side conductor area that is a sum of conductor areas of the inductor conductor closest to the bottom surface to the N/2th inductor conductor.

### CROSS-REFERENCE TO RELATED APPLICATION

This application claims benefit of priority to Japanese Patent Application No. 2022-185943, filed Nov. 21, 2022, the entire content of which is incorporated herein by reference.

### BACKGROUND

### Technical Field

The present disclosure relates to a multilayer inductor component.

### Background Art

A multilayer inductor component described in Unexamined Patent Application Publication No. 2021-136336 includes a rectangular parallelepiped-shaped element body. Accordingly, the element body has six outer surfaces. One of the six faces of the element body is a bottom surface opposed to a substrate at mounting of the inductor component to the substrate or the like. Two of the remaining five faces are a first end surface perpendicular to the bottom surface and a second end surface parallel to the first end surface. In addition, the element body includes a first electrode and a second electrode that are exposed to the outside of the element body. The first electrode extends from the first end surface to the bottom surface. The second electrode extends from the second end surface to the bottom surface.

The above-mentioned multilayer inductor component has an inductor wire extending within the element body. The inductor wire spirally extends around an orthogonal axis orthogonal to the bottom surface. Specifically, the inductor wire includes a plurality of inductor conductors and a plurality of via conductors. Each inductor conductor extends parallel to the bottom surface. The inductor conductors are spaced in the direction along the above-described orthogonal axis. Each via conductor interconnects adjacent inductor conductors in a direction along the orthogonal axis.

### SUMMARY

In the multilayer inductor component described in Unexamined Patent Application Publication No. 2021-136336, stray capacitance occurs between the inductor wire and each electrode, and between the inductor wire and the electrodes on the substrate. If excessively large stray capacitance occurs, a Q value of the multilayer inductor component can lower.

A multilayer inductor component according to the present disclosure includes a rectangular parallelepiped-shaped element body having six outer surfaces; and an inductor wire extending within the element body. The element body has an electrode connected to the inductor wire. Given that, among the six outer surfaces of the element body, a particular one surface is a bottom surface and a surface parallel to the bottom surface is a top surface. The electrode is exposed to outside of the element body on the bottom surface. The inductor wire has a plurality of inductor conductors extending parallel to the bottom surface and via conductors extending along an orthogonal axis orthogonal to the bottom surface, the inductor conductors are spaced along the orthogonal axis, and the via conductor interconnects the inductor conductors adjacent to each other in a direction along the orthogonal axis. Also, given that an area of each of the inductor conductors when viewed in the direction along the orthogonal axis is a conductor area, and the number of the inductor conductors is N, in the direction along the orthogonal axis, a top surface-side conductor area that is a sum of the conductor areas of the inductor conductor closest to the top surface to the N/2th (round down a decimal point) inductor conductor is 1.1 times or more of a bottom surface-side conductor area that is a sum of the conductor areas of the inductor conductor closest to the bottom surface to the N/2th (round down a decimal point) inductor conductor.

With the above-described configuration, on the side closer to the bottom surface, the conductor area of the inductor conductor opposed to the electrode can be reduced. This can reduce stray capacitance that occurs between the electrode and the inductor conductor. Accordingly, the Q value of the multilayer inductor component can be increased.

The Q value of the multilayer inductor component can be enhanced.

### BRIEF DESCRIPTION OF THE DRAWINGS

FIG. 1 is a schematic configuration view illustrating a multilayer inductor component;

FIG. 2 is an exploded perspective view of the multilayer inductor component;

FIG. 3 is an exploded perspective view of a multilayer inductor component in a comparative example;

FIG. 4 is a graph illustrating results of simulation for the multilayer inductor component and the multilayer inductor component in the comparative example as targets; and

FIG. 5 is an exploded perspective view of a multilayer inductor component in a modification example.

### DETAILED DESCRIPTION

An embodiment of an inductor component will be described below. For facilitation of understanding, components may be enlarged in some figures. The dimension ratio of the components may be different from the actual ratio or the ratio in other figures.

Overall Configuration of Multilayer Inductor Component

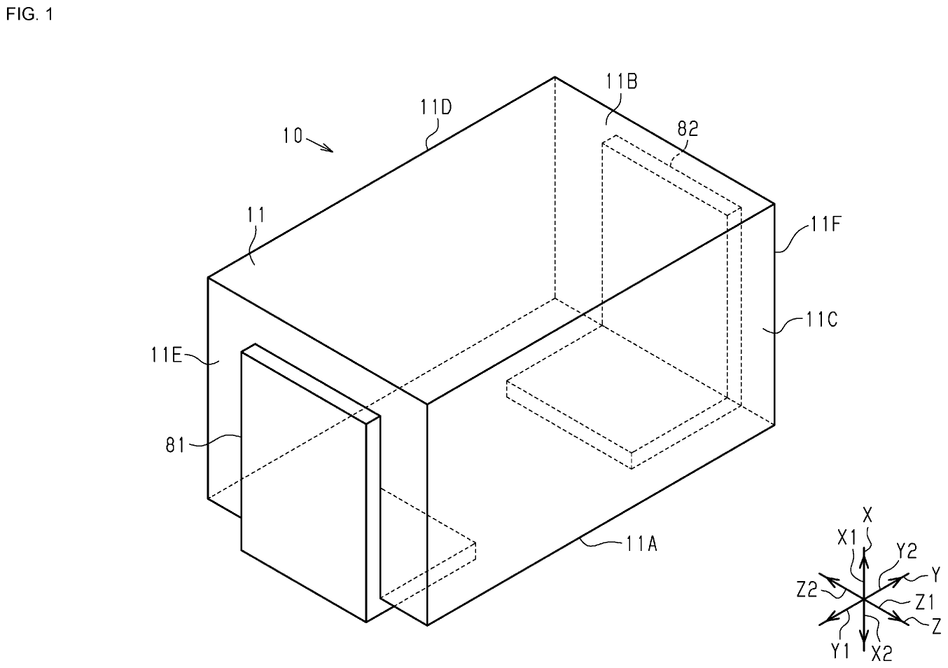

As illustrated in FIG. 1, a multilayer inductor component 10 includes a rectangular parallelepiped-shaped element body 11.

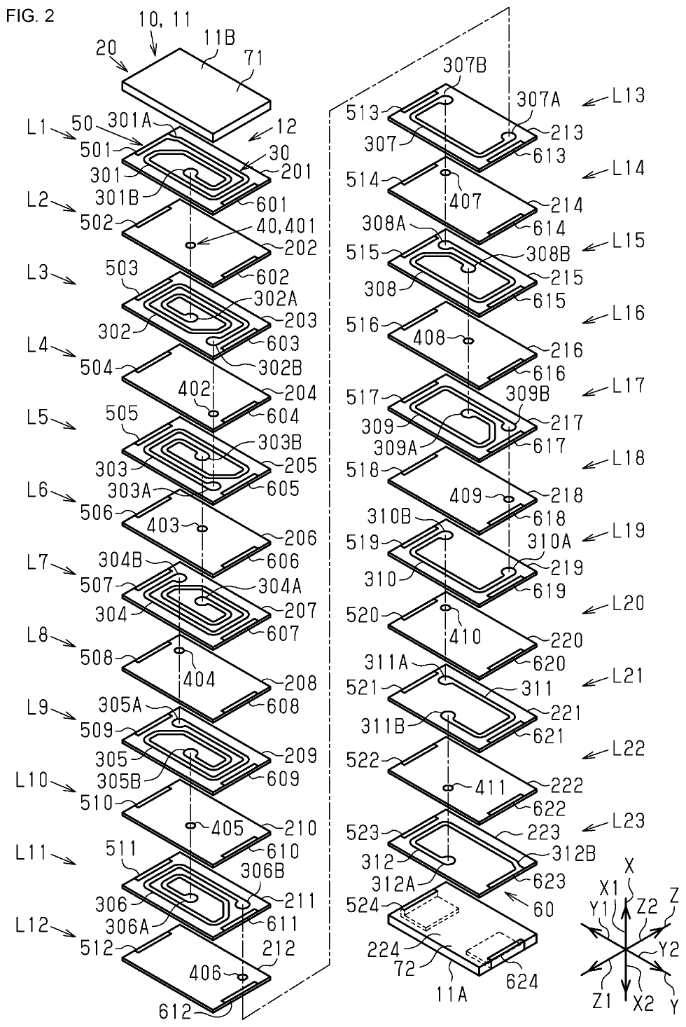

As illustrated in FIG. 2, the multilayer inductor component 10 is, as a whole, configured by laminating a plurality of plate-like layers. In addition, each of the layers is rectangular in a plan view. The rectangular parallelepiped-shaped element body 11 has six outer surfaces. As illustrated in FIG. 1, among the six outer surfaces, one particular surface parallel to a principal surface in each layer is defined as a bottom surface 11A. It is noted that the bottom surface 11A is a surface opposed to a substrate when the multilayer inductor component 10 is mounted to the substrate. A surface parallel to the bottom surface 11A is defined as a top surface 11B. One particular surface perpendicular to the bottom surface 11A is defined as a first principal surface 11C. In addition, a surface parallel to the first principal surface 11C is defined as a second principal surface 11D. Further, one particular surface perpendicular to both of the bottom surface 11A and the first principal surface 11C is defined as a first end surface 11E. In addition, a surface parallel to the first end surface 11E is defined as a second end surface 11F.

In the following description, an axis along a direction in which the plurality of layers are laminated, that is, an axis perpendicular to the bottom surface 11A is defined as an orthogonal axis. The orthogonal axis is defined as a first axis X. In addition, an axis perpendicular to the first end surface 11E is defined as a second axis Y Further, an axis perpendicular to the first principal surface 11C is defined as a third axis Z. Among directions along the first axis X, a direction toward the top surface 11B is defined as a first positive direction X1, and an opposite direction to the first positive direction X1 is defined as a first negative direction X2. In addition, among directions along the second axis Y, a direction toward the first end surface 11E is defined as a second positive direction Y1, and an opposite direction to the second positive direction Y1 is defined as a second negative direction Y2. Further, among directions along the third axis Z, a direction toward the first principal surface 11C is defined as a third positive direction Z1, and an opposite direction to the third positive direction Z1 is defined as a third negative direction Z2.

In this embodiment, a long side of the bottom surface 11A is parallel to the second axis Y A short side of the bottom surface 11A is parallel to the third axis Z. A length of the long side of the bottom surface 11A is 0.4 mm. A length of a short side of the bottom surface 11A is 0.2 mm. As described above, the multilayer inductor component 10 has a size defined by so-called 0402.

As illustrated in FIG. 2, multilayer inductor component 10 includes an inductor wire 12. The inductor wire 12 extends within the element body 11. The inductor wire 12 has twelve inductor conductors 30 and eleven via conductors 40. Each inductor conductor 30 extends parallel to the bottom surface 11A. Each via conductor 40 extends along the first axis X. It is noted that in FIG. 2, a reference numeral “30” is assigned to only one inductor conductor 30. It is noted that in FIG. 2, a reference numeral “40” is assigned to only one via conductors 40.

The multilayer inductor component 10 further includes a first electrode 50 and a second electrode 60. The first electrode 50 is connected to a first end portion of the inductor wire 12. The second electrode 60 is connected to a second end portion of the inductor wire 12.

As illustrated in FIG. 2, the multilayer inductor component 10 has a first layer L1 to a twenty-third layer L23. The first layer L1 to the twenty-third layer L23 are aligned in this order in the first negative direction X2. Thickness of the first layer L1 to the twenty-third layer L23, that is, dimension in the direction along the first axis X is substantially uniform.

The first layer L1 is configured of a first electrode portion 501, a second electrode portion 601, a first inductor conductor 301, and first insulating portion 201.

The first electrode portion 501 is made of a conductive material such as silver. The first electrode portion 501 extends parallel to the third axis Z and along an edge of the first layer L1 on the side of the second positive direction Y1. The maximum dimension of the first electrode portion 501 in the direction along the third axis Z is smaller than the dimension of the first layer L1 in the direction along the third axis Z. The first electrode portion 501 is located at the center of the first layer L1 in the direction along the third axis Z.

The second electrode portion 601 is made of a conductive material such as silver. The second electrode portion 601 extends parallel to the third axis Z and along an edge of the first layer L1 on the side of the second negative direction Y2. The maximum dimension of the second electrode portion 601 in the direction along the third axis Z is smaller than the dimension in the first layer L1 in the direction along the third axis Z. The second electrode portion 601 is located at the center of the first layer L1 in the direction along the third axis Z.

The first inductor conductor 301 is made of a conductive material such as silver. When the first layer L1 is viewed in the first negative direction X2, the first inductor conductor 301, as a whole, spirally extends substantially around the geometrical center of the first layer L1. When viewed in the first negative direction X2, a first end portion 301A of the first inductor conductor 301 is a portion offset from a circling path configured by overlapping the inductor conductors 30 in the first layer L1 to the twenty-third layer L23. The first end portion 301A is connected to an end portion of the first electrode portion 501 on the side of the third negative direction Z2. It is noted that first end portion 301A is a first end portion of the entire inductor wire 12.

A second end portion 301B of the first inductor conductor 301 is substantially circular. The second end portion 301B of the first inductor conductor 301 functions as a land for connection of a via conductor 401 described below. When the first layer L1 is viewed in the first negative direction X2, a position of the second end portion 301B of the first inductor conductor 301 in the direction along the second axis Y is substantially the geometrical center of the first layer L1. In addition, a position of the second end portion 301B of the first inductor conductor 301 in the direction along the third axis Z is located on the side of the third positive direction Z1 relative to the geometrical center of the first layer L1.

When the first layer L1 is viewed in the first negative direction X2, the first inductor conductor 301 extends clockwise from the first end portion 301A toward the second end portion 301B. In addition, the number of turns of the first inductor conductor 301 is about 1.5 turns. It is noted that the number of turns is defined as follows.

The number of turns of each inductor conductor 30 is determined based on a virtual vector. A start point of the virtual vector is disposed on a virtual centerline that passes through the center of the wire width of the inductor conductor 30 and extends in the extending direction of the inductor conductor 30. When viewed in a normal direction, a start point of the inductor conductor 30 is moved from one end to the other end of the virtual centerline. Here, when the orientation of the virtual vector rotates by 360 degrees, the number of turns is determined as 1.0 turn. Accordingly, when the inductor conductor is wound by 180 degrees, for example, the number of turns becomes 0.5 turn.

The inductor conductors 30 have a uniform wire width is uniform except the first end portion and the second end portion. It is noted that the wire width is defined as follows. That is, the shortest line segment that can be drawn from an arbitrary point on the edge of the certain inductor conductor 30 to an opposite edge is specified. A length of the specified line segment is the wire width at the above-described arbitrary point. In addition, the uniform wire width includes manufacturing error or the like. In other words, the uniform wire width means that a difference from an average value for the wire width is 20% of the average value or less.

In the first layer L1, a portion except the first electrode portion 501, the second electrode portion 601, and the first inductor conductor 301 is the first insulating portion 201. The first insulating portion 201 is configured of a nonmagnetic insulator made of glass, resin, alumina, or the like.

As illustrated in FIG. 2, the second layer L2 is laminated onto the principal surface of the first layer L1 facing the first negative direction X2. When the second layer L2 is viewed in the first negative direction X2, similar to the first layer L1, the second layer L2 is rectangular. The second layer L2 is configured of a third electrode portion 502, a fourth electrode portion 602, a via conductor 401, and a second insulating portion 202.

The third electrode portion 502 is made of the same material as that of the first electrode portion 501. When the second layer L2 is viewed in the first negative direction X2, the third electrode portion 502 has the same dimension as the first electrode portion 501, and is located at the same position as the first electrode portion 501. Accordingly, the third electrode portion 502 is laminated onto a face of the first electrode portion 501 facing the first negative direction X2.

The fourth electrode portion 602 is made of the same material as that of the second electrode portion 601. When the second layer L2 is viewed in the first negative direction X2, the fourth electrode portion 602 has the same dimension as the second electrode portion 601, and is located at the same position as the second electrode portion 601. Accordingly, the fourth electrode portion 602 is laminated onto a face of the second electrode portion 601 facing the first negative direction X2.

The via conductor 401 is made of the same material as that of the first inductor conductor 301. The via conductor 401 is shaped like a cylinder extending along the first axis X. The via conductor 401 is laminated onto the second end portion 301B of the first inductor conductor 301 facing the first negative direction X2. Thus, via conductor 401 is electrically connected to the second end portion 301B of the first inductor conductor 301. The via conductor 401 extends from the second end portion 301B of the first inductor conductor 301 in the first negative direction X2.

In the second layer L2, a portion except the third electrode portion 502, the fourth electrode portion 602, and the via conductor 401 is the second insulating portion 202. The second insulating portion 202 is configured of a nonmagnetic insulator made of the same material as that of the first insulating portion 201.

The third layer L3 is laminated onto the principal surface of the second layer L2 facing the first negative direction X2. When the third layer L3 is viewed in the first negative direction X2, similar to the first layer L1, the third layer L3 is rectangular. The third layer L3 is configured of a fifth electrode portion 503, a sixth electrode portion 603, a second inductor conductor 302, and a third insulating portion 203.

The fifth electrode portion 503 is made of the same material as that of the first electrode portion 501. When the third layer L3 is viewed in the first negative direction X2, the fifth electrode portion 503 has the same dimension as the third electrode portion 502, and is located at the same position as the third electrode portion 502. Accordingly, the fifth electrode portion 503 is laminated onto the face of the third electrode portion 502 facing the first negative direction X2.

The sixth electrode portion 603 is made of the same material as that of the second electrode portion 601. When the third layer L3 is viewed in the first negative direction X2, the sixth electrode portion 603 has the same dimension as the fourth electrode portion 602, and is located at the same position as the fourth electrode portion 602. Accordingly, sixth electrode portion 603 is laminated onto the face of the fourth electrode portion 602 facing the first negative direction X2.

The second inductor conductor 302 is made of the same material as that of the first inductor conductor 301. When the third layer L3 is viewed in the first negative direction X2, the second inductor conductor 302, as a whole, spirally extends substantially around the geometrical center of the third layer L3. A first end portion 302A of the second inductor conductor 302 is substantially circular. The first end portion 302A of the second inductor conductor 302 is located on the face of the via conductor 401 facing the first negative direction X2. Thus, the first end portion 302A of the second inductor conductor 302 is connected to the via conductor 401.

A second end portion 302B of the second inductor conductor 302 is substantially circular. A position of the second end portion 302B in the direction along the second axis Y is located on the side of the second negative direction Y2 relative to the geometrical center of the third layer L3. A position of the second end portion 302B of the second inductor conductor 302 in the direction along the third axis Z is located on the side of the third positive direction Z1 relative to the geometrical center of the third layer L3. When the third layer L3 is viewed in the first negative direction X2, the second inductor conductor 302 extends clockwise from the first end portion 302A toward the second end portion 302B. In addition, the number of turns of the second inductor conductor 302 is about 1.75 turns. Here, the wire length of the first inductor conductor 301 that does not include the first end portion 301A and includes the second end portion 301B is defined as 1 unit. In this case, the second inductor conductor 302 has a wire length of about 1.04 turns. In addition, the wire width of the second inductor conductor 302 is the same as that of the first inductor conductor 301.

In the third layer L3, a portion except the fifth electrode portion 503, the sixth electrode portion 603, and the second inductor conductor 302 is the third insulating portion 203. The third insulating portion 203 is configured of a nonmagnetic insulator made of the same material as that of the first insulating portion 201.

The fourth layer L4 is laminated onto the principal surface of the third layer L3 facing the first negative direction X2. When the fourth layer L4 is viewed in the first negative direction X2, similar to the first layer L1, the fourth layer L4 is rectangular. The fourth layer L4 is configured of a seventh electrode portion 504, and an eighth electrode portion 604, a via conductor 402, and a fourth insulating portion 204.

The seventh electrode portion 504 is made of the same material as that of the first electrode portion 501. When the fourth layer L4 is viewed in the first negative direction X2, the seventh electrode portion 504 has the same dimension as the fifth electrode portion 503, and is located at the same position as the fifth electrode portion 503. Accordingly, the seventh electrode portion 504 is laminated onto the face of the fifth electrode portion 503 facing the first negative direction X2.

The eighth electrode portion 604 is made of the same material as that of the second electrode portion 601. When the fourth layer L4 is viewed in the first negative direction X2, the eighth electrode portion 604 has the same dimension as the sixth electrode portion 603, and is located at the same position as the sixth electrode portion 603. Accordingly, the eighth electrode portion 604 is laminated onto the face of the sixth electrode portion 603 facing the first negative direction X2.

The via conductor 402 is made of the same material as that of the first inductor conductor 301. The via conductor 402 is shaped like a cylinder extending along the first axis X. The via conductor 402 is laminated onto the face of the second end portion 302B of the second inductor conductor 302 facing the first negative direction X2. For this reason, the via conductor 402 is electrically connected to the second end portion 302B of the second inductor conductor 302. The via conductor 402 extends from the second end portion 302B of the second inductor conductor 302 in the first negative direction X2.

In the fourth layer L4, a portion except the seventh electrode portion 504, the eighth electrode portion 604, and the via conductor 402 is the fourth insulating portion 204. The fourth insulating portion 204 is configured of a nonmagnetic insulator made of the same material as that of the first insulating portion 201.

The fifth layer L5 is laminated onto the principal surface of the fourth layer L4 facing the first negative direction X2. When the fifth layer L5 is viewed in the first negative direction X2, similar to the first layer L1, the fifth layer L5 is rectangular. The fifth layer L5 is configured of a ninth electrode portion 505, a tenth electrode portion 605, a third inductor conductor 303, and a fifth insulating portion 205.

The ninth electrode portion 505 is made of the same material as that of the first electrode portion 501. When the fifth layer L5 is viewed in the first negative direction X2, the ninth electrode portion 505 has the same dimension as the seventh electrode portion 504, and is located at the same position as the seventh electrode portion 504. Accordingly, the ninth electrode portion 505 is laminated onto the face of the seventh electrode portion 504 facing the first negative direction X2.

The tenth electrode portion 605 is made of the same material as that of the second electrode portion 601. When the fifth layer L5 is viewed in the first negative direction X2, the tenth electrode portion 605 has the same dimension as the eighth electrode portion 604, and is located at the same position as the eighth electrode portion 604. Accordingly, the tenth electrode portion 605 is laminated onto the face of the eighth electrode portion 604 facing the first negative direction X2.

The third inductor conductor 303 is made of the same material as that of the first inductor conductor 301. When the fifth layer L5 is viewed in the first negative direction X2, the third inductor conductor 303, as a whole, spirally extends substantially around the geometrical center of the fifth layer L5. A first end portion 303A of the third inductor conductor 303 is substantially circular. The first end portion 303A of the third inductor conductor 303 is located on the face of the via conductor 402 facing the first negative direction X2. For this reason, the first end portion 303A of the third inductor conductor 303 is connected to the via conductor 402.

A second end portion 303B of the third inductor conductor 303 is substantially circular. A position of the second end portion 303B in the direction along the second axis Y is substantially the geometrical center of the fifth layer L5. A position of the second end portion 303B of the third inductor conductor 303 in the direction along the third axis Z is located on the side of the third negative direction Z2 relative to the geometrical center of the fifth layer L5. When the fifth layer L5 is viewed in the first negative direction X2, the third inductor conductor 303 extends clockwise from the first end portion 303A toward the second end portion 303B. In addition, the third inductor conductor 303 has the number of turns of about 1.5 turns. The third inductor conductor 303 has a wire length of about 1 unit. The wire width of the third inductor conductor 303 is the same as that of the first inductor conductor 301.

In the fifth layer L5, a portion except the ninth electrode portion 505, the tenth electrode portion 605, and the third inductor conductor 303 is the fifth insulating portion 205. The fifth insulating portion 205 is configured of a nonmagnetic insulator made of the same material as that of the first insulating portion 201.

The sixth layer L6 is laminated onto the principal surface of the fifth layer L5 facing the first negative direction X2. When the sixth layer L6 is viewed in the first negative direction X2, similar to the first layer L1, the sixth layer L6 is rectangular. The sixth layer L6 is configured of an eleventh electrode portion 506, a twelfth electrode portion 606, a via conductor 403, and a sixth insulating portion 206.

The eleventh electrode portion 506 is made of the same material as that of the first electrode portion 501. When the sixth layer L6 is viewed in the first negative direction X2, the eleventh electrode portion 506 has the same dimension as the ninth electrode portion 505, and is located at the same position as the ninth electrode portion 505. Accordingly, the eleventh electrode portion 506 is laminated onto the face of the ninth electrode portion 505 facing the first negative direction X2.

The twelfth electrode portion 606 is made of the same material as that of the second electrode portion 601. When the sixth layer L6 is viewed in the first negative direction X2, the twelfth electrode portion 606 has the same dimension as the tenth electrode portion 605, and is located at the same position as the tenth electrode portion 605. Accordingly, the twelfth electrode portion 606 is laminated onto the face of the tenth electrode portion 605 facing the first negative direction X2.

The via conductor 403 is made of the same material as that of the first inductor conductor 301. The via conductor 403 is shaped like a cylinder extending along the first axis X. The via conductor 403 is laminated onto the face of the second end portion 303B of the third inductor conductor 303 facing the first negative direction X2. Thus, the via conductor 403 is electrically connected to the second end portion 303B of the third inductor conductor 303. The via conductor 403 extends from the second end portion 303B of the third inductor conductor 303 in the first negative direction X2.

In the sixth layer L6, a portion except the eleventh electrode portion 506, the twelfth electrode portion 606, the via conductor 403 is the sixth insulating portion 206. The sixth insulating portion 206 is configured of a nonmagnetic insulator made of the same material as that of the first insulating portion 201.

The seventh layer L7 is laminated onto the principal surface of the sixth layer L6 facing the first negative direction X2. When the seventh layer L7 is viewed in the first negative direction X2, similar to the first layer L1, the seventh layer L7 is rectangular. The seventh layer L7 is configured of a thirteenth electrode portion 507, a fourteenth electrode portion 607, a fourth inductor conductor 304, and a seventh insulating portion 207.

The thirteenth electrode portion 507 is made of the same material as that of the first electrode portion 501. When the seventh layer L7 is viewed in the first negative direction X2, the thirteenth electrode portion 507 has the same dimension as the eleventh electrode portion 506, and is located at the same position as the eleventh electrode portion 506. Accordingly, the thirteenth electrode portion 507 is laminated onto the face of the eleventh electrode portion 506 facing the first negative direction X2.

The fourteenth electrode portion 607 is made of the same material as that of the second electrode portion 601. When the seventh layer L7 is viewed in the first negative direction X2, the fourteenth electrode portion 607 has the same dimension as the twelfth electrode portion 606, and is located at the same position as the twelfth electrode portion 606. Accordingly, the fourteenth electrode portion 607 is laminated onto the face of the twelfth electrode portion 606 facing the first negative direction X2.

The fourth inductor conductor 304 is made of the same material as that of the first inductor conductor 301. When the seventh layer L7 is viewed in the first negative direction X2, the fourth inductor conductor 304, as a whole, spirally extends substantially around the geometrical center of the seventh layer L7. A first end portion 304A of the fourth inductor conductor 304 is substantially circular. The first end portion 304A of the fourth inductor conductor 304 is located on the face of the via conductor 403 facing the first negative direction X2. Thus, the first end portion 304A of the fourth inductor conductor 304 is connected to the via conductor 403.

A second end portion 304B of the fourth inductor conductor 304 is substantially circular. A position of the second end portion 304B of the fourth inductor conductor 304 in the direction along the second axis Y is located on the side of the second positive direction Y1 relative to the geometrical center of the seventh layer L7. A position of the second end portion 304B of the fourth inductor conductor 304 in the direction along the third axis Z is located on the third negative direction Z2 relative to the geometrical center of the seventh layer L7. When the seventh layer L7 is viewed in the first negative direction X2, the fourth inductor conductor 304 extends clockwise from the first end portion 304A toward the second end portion 304B. In addition, the fourth inductor conductor 304 has the number of turns of about 1.75 turns. The fourth inductor wire has a wire length of about 1.04 units. The wire width of the fourth inductor conductor 304 is the same as that of the first inductor conductor 301.

In the seventh layer L7, a portion except the thirteenth electrode portion 507, the fourteenth electrode portion 607, and the fourth inductor conductor 304 is the seventh insulating portion 207. The seventh insulating portion 207 is configured of a nonmagnetic insulator made of the same material as that of the first insulating portion 201.

The eighth layer L8 is laminated onto the principal surface of the seventh layer L7 facing the first negative direction X2. When the eighth layer L8 is viewed in the first negative direction X2, similar to the first layer L1, the eighth layer L8 is rectangular. The eighth layer L8 is configured of a fifteenth electrode portion 508, a sixteenth electrode portion 608, a via conductor 404, and an eighth insulating portion 208.

The fifteenth electrode portion 508 is made of the same material as that of the first electrode portion 501. When the eighth layer L8 is viewed in the first negative direction X2, the fifteenth electrode portion 508 has the same dimension as the thirteenth electrode portion 507, and is located at the same position as the thirteenth electrode portion 507. Accordingly, the fifteenth electrode portion 508 is laminated onto the face of the thirteenth electrode portion 507 facing the first negative direction X2.

The sixteenth electrode portion 608 is made of the same material as that of the second electrode portion 601. When the eighth layer L8 is viewed in the first negative direction X2, the sixteenth electrode portion 608 has the same dimension as the fourteenth electrode portion 607, and is located at the same position as the fourteenth electrode portion 607. Accordingly, the sixteenth electrode portion 608 is laminated onto the face of the fourteenth electrode portion 607 facing the first negative direction X2.

The via conductor 404 is made of the same material as that of the first inductor conductor 301. The via conductor 404 is shaped like a cylinder extending along the first axis X. The via conductor 404 is laminated onto the face of the second end portion 304B of the fourth inductor conductor 304 facing the first negative direction X2. Thus, via conductor 404 is electrically connected to the second end portion 304B of the fourth inductor conductor 304. The via conductor 404 extends from the second end portion 304B of the fourth inductor conductor 304 in the first negative direction X2.

In the eighth layer L8, a portion except the fifteenth electrode portion 508, the sixteenth electrode portion 608, the via conductor 404 is the eighth insulating portion 208. The eighth insulating portion 208 is configured of a nonmagnetic insulator made of the same material as that of the first insulating portion 201.

The ninth layer L9 is laminated onto the principal surface of the eighth layer L8 facing the first negative direction X2. When the ninth layer L9 is viewed in the first negative direction X2, similar to the first layer L1, the ninth layer L9 is rectangular. The ninth layer L9 is configured of a seventeenth electrode portion 509, an eighteenth electrode portion 609, a fifth inductor conductor 305, and a ninth insulating portion 209.

The seventeenth electrode portion 509 is made of the same material as that of the first electrode portion 501. When the ninth layer L9 is viewed in the first negative direction X2, the seventeenth electrode portion 509 has the same dimension as the fifteenth electrode portion 508, and is located at the same position as the fifteenth electrode portion 508. Accordingly, the seventeenth electrode portion 509 is laminated onto the face of the fifteenth electrode portion 508 facing the first negative direction X2.

The eighteenth electrode portion 609 is made of the same material as that of the second electrode portion 601. When the ninth layer L9 is viewed in the first negative direction X2, the eighteenth electrode portion 609 has the same dimension as the sixteenth electrode portion 608, and is located at the same position as the sixteenth electrode portion 608. Accordingly, the eighteenth electrode portion 609 is laminated onto the face of the sixteenth electrode portion 608 facing the first negative direction X2.

The fifth inductor conductor 305 is made of the same material as that of the first inductor conductor 301. When the ninth layer L9 is viewed in the first negative direction X2, the fifth inductor conductor 305, as a whole, spirally extends substantially around the geometrical center of the ninth layer L9. A first end portion 305A of the fifth inductor conductor 305 is substantially circular. The first end portion 305A of the fifth inductor conductor 305 is located on the face of the via conductor 404 facing the first negative direction X2. Thus, the first end portion 305A of the fifth inductor conductor 305 is connected to the via conductor 404.

A second end portion 305B of the fifth inductor conductor 305 is substantially circular. When the ninth layer L9 is viewed in the first negative direction X2, the second end portion 305B of the fifth inductor conductor 305 is located at the same position as the second end portion 301B of the first inductor conductor 301. When the ninth layer L9 is viewed in the first negative direction X2, the fifth inductor conductor 305 extends clockwise from the first end portion 305A toward the second end portion 305B. In addition, the fifth inductor conductor 305 has the number of turns of about 1.5 turns. The fifth inductor conductor 305 has a wire length of about 1 unit. The wire width of the fifth inductor conductor 305 is the same as that of the first inductor conductor 301.

In the ninth layer L9, a portion except the seventeenth electrode portion 509, the eighteenth electrode portion 609, and the fifth inductor conductor 305 is the ninth insulating portion 209. The ninth insulating portion 209 is configured of an insulator made of the same material as that of the first insulating portion 201.

The tenth layer L10 is laminated onto the principal surface of the ninth layer L9 facing the first negative direction X2. When the tenth layer L10 is viewed in the first negative direction X2, similar to the first layer L1, the tenth layer L10 is rectangular. The tenth layer L10 is configured of nineteenth electrode portion 510, a twentieth electrode portion 610, a via conductor 405, and a tenth insulating portion 210.

The nineteenth electrode portion 510 is made of the same material as that of the first electrode portion 501. When the tenth layer L10 is viewed in the first negative direction X2, the nineteenth electrode portion 510 has the same dimension as the seventeenth electrode portion 509, and is located at the same position as the seventeenth electrode portion 509. Accordingly, the nineteenth electrode portion 510 is laminated onto the face of the seventeenth electrode portion 509 facing the first negative direction X2.

The twentieth electrode portion 610 is made of the same material as that of the second electrode portion 601. When the tenth layer L10 is viewed in the first negative direction X2, the twentieth electrode portion 610 has the same dimension as the eighteenth electrode portion 609, and is located at the same position as the eighteenth electrode portion 609. Accordingly, the twentieth electrode portion 610 is laminated onto the face of the eighteenth electrode portion 609 facing the first negative direction X2.

The via conductor 405 is made of the same material as that of the first inductor conductor 301. The via conductor 405 is shaped like a cylinder extending along the first axis X. The via conductor 405 is laminated onto the face of the second end portion 305B of the fifth inductor conductor 305 facing the first negative direction X2. Thus, the via conductor 405 is electrically connected to the second end portion 305B of the fifth inductor conductor 305. The via conductor 405 extends from the second end portion 305B of the fifth inductor conductor 305 in the first negative direction X2.

In the tenth layer L10, a portion except the nineteenth electrode portion 510, the twentieth electrode portion 610, and the via conductor 405 is the tenth insulating portion 210. The tenth insulating portion 210 is configured of a nonmagnetic insulator made of the same material as that of the first insulating portion 201.

The eleventh layer L11 is laminated onto the principal surface of the tenth layer L10 facing the first negative direction X2. When the eleventh layer L11 is viewed in the first negative direction X2, similar to the first layer L1, the eleventh layer L11 is rectangular. The eleventh layer L11 is configured of a twenty-first electrode portion 511, a twenty-second electrode portion 611, a sixth inductor conductor 306, and an eleventh insulating portion 211.

The twenty-first electrode portion 511 is made of the same material as that of the first electrode portion 501. When the eleventh layer L11 is viewed in the first negative direction X2, the twenty-first electrode portion 511 has the same dimension as the nineteenth electrode portion 510, and is located at the same position as the nineteenth electrode portion 510. Accordingly, the twenty-first electrode portion 511 is laminated onto the face of the nineteenth electrode portion 510 facing the first negative direction X2.

The twenty-second electrode portion 611 is made of the same material as that of the second electrode portion 601. When the eleventh layer L11 is viewed in the first negative direction X2, the twenty-second electrode portion 611 has the same dimension as the twentieth electrode portion 610, and is located at the same position as the twentieth electrode portion 610. Accordingly, the twenty-second electrode portion 611 is laminated onto the face of the twentieth electrode portion 610 facing the first negative direction X2.

The sixth inductor conductor 306 is made of the same material as that of the first inductor conductor 301. When the eleventh layer L11 is viewed in the first negative direction X2, sixth inductor conductor 306, as a whole, spirally extends substantially around the geometrical center of the eleventh layer L11. A first end portion 306A of the sixth inductor conductor 306 is substantially circular. The first end portion 306A of the sixth inductor conductor 306 is located on the face of the via conductor 405 facing the first negative direction X2. Thus, the first end portion 306A of the sixth inductor conductor 306 is connected to the via conductor 405.

A second end portion 306B of the sixth inductor conductor 306 is substantially circular. A position of the second end portion 306B in the direction along the second axis Y is located on the side of the second negative direction Y2 relative to the geometrical center of the eleventh layer L11. In addition, a position of the second end portion 306B in the direction along the third axis Z is located on the side of the third negative direction Z2 relative to the geometrical center of the eleventh layer L11. When the eleventh layer L11 is viewed in the first negative direction X2, the sixth inductor conductor 306 extends clockwise from first end portion 306A toward the second end portion 306B. In addition, the sixth inductor conductor 306 has the number of turns of about 1.5 turns. The sixth inductor conductor 306 has a wire length of about 1 unit. The wire width of the sixth inductor conductor 306 is the same as that of the first inductor conductor 301.

In the eleventh layer L11, a portion except the twenty-first electrode portion 511, the twenty-second electrode portion 611, and the sixth inductor conductor 306 is the eleventh insulating portion 211. The eleventh insulating portion 211 is configured of an insulator made of the same material as that of the first insulating portion 201.

The twelfth layer L12 is laminated onto the principal surface of the eleventh layer L11 facing the first negative direction X2. When the twelfth layer L12 is viewed in the first negative direction X2, similar to the first layer L1, the twelfth layer L12 is rectangular. The twelfth layer L12 is configured of a twenty-third electrode portion 512, a twenty-fourth electrode portion 612, a via conductor 406, and a twelfth insulating portion 212.

The twenty-third electrode portion 512 is made of the same material as that of the first electrode portion 501. When the twelfth layer L12 is viewed in the first negative direction X2, the twenty-third electrode portion 512 has the same dimension as the twenty-first electrode portion 511, and is located at the same position as the twenty-first electrode portion 511. Accordingly, the twenty-third electrode portion 512 is laminated onto the face of the twenty-first electrode portion 511 facing the first negative direction X2.

The twenty-fourth electrode portion 612 is made of the same material as that of the second electrode portion 601. When the twelfth layer L12 is viewed in the first negative direction X2, the twenty-fourth electrode portion 612 has the same dimension as the twenty-second electrode portion 611, and is located at the same position as the twenty-second electrode portion 611. Accordingly, the twenty-fourth electrode portion 612 is laminated onto the face of the twenty-second electrode portion 611 facing the first negative direction X2.

The via conductor 406 is made of the same material as that of the first inductor conductor 301. The via conductor 406 is shaped like a cylinder extending along the first axis X. The via conductor 406 is laminated onto the face of the second end portion 306B of the sixth inductor conductor 306 facing the first negative direction X2. Thus, the via conductor 406 is electrically connected to the second end portion 306B of the sixth inductor conductor 306. The via conductor 406 extends from the second end portion 306B of the sixth inductor conductor 306 in the first negative direction X2.

In the twelfth layer L12, a portion except the twenty-third electrode portion 512, the twenty-fourth electrode portion 612, and the via conductor 406 is the twelfth insulating portion 212. The twelfth insulating portion 212 is configured of a nonmagnetic insulator made of the same material as that of the first insulating portion 201.

The thirteenth layer L13 is laminated onto the principal surface of the twelfth layer L12 facing the first negative direction X2. When the thirteenth layer L13 is viewed in the first negative direction X2, similar to the first layer L1, the thirteenth layer L13 is rectangular. The thirteenth layer L13 is configured of a twenty-fifth electrode portion 513, a twenty-sixth electrode portion 613, a seventh inductor conductor 307, and a thirteenth insulating portion 213.

The twenty-fifth electrode portion 513 is made of the same material as that of the first electrode portion 501. When the thirteenth layer L13 is viewed in the first negative direction X2, the twenty-fifth electrode portion 513 has the same dimension as the twenty-third electrode portion 512, and is located at the same position as the twenty-third electrode portion 512. Accordingly, the twenty-fifth electrode portion 513 is laminated onto the face of the twenty-third electrode portion 512 facing the first negative direction X2.

The twenty-sixth electrode portion 613 is made of the same material as that of the second electrode portion 601. When the thirteenth layer L13 is viewed in the first negative direction X2, the twenty-sixth electrode portion 613 has the same dimension as the twenty-fourth electrode portion 612, and is located at the same position as the twenty-fourth electrode portion 612. Accordingly, the twenty-sixth electrode portion 613 is laminated onto the face of the twenty-fourth electrode portion 612 facing the first negative direction X2.

The seventh inductor conductor 307 is made of the same material as that of the first inductor conductor 301. When the thirteenth layer L13 is viewed in the first negative direction X2, the seventh inductor conductor 307, as a whole, spirally extends substantially around the geometrical center of the thirteenth layer L13. A first end portion 307A of the seventh inductor conductor 307 is substantially circular. The first end portion 307A of the seventh inductor conductor 307 is located on the face of the via conductor 406 facing the first negative direction X2. Thus, the first end portion 307A of the seventh inductor conductor 307 is connected to the via conductor 406.

A second end portion 307B of the seventh inductor conductor 307 is substantially circular. When the thirteenth layer L13 is viewed in the first negative direction X2, the second end portion 307B is located at the same position as the second end portion 304B of the fourth inductor conductor 304. When the thirteenth layer L13 is viewed in the first negative direction X2, the seventh inductor conductor 307 extends clockwise from the first end portion 307A toward the second end portion 307B. In addition, the seventh inductor conductor 307 has the number of turns of about 0.5 turn. The seventh inductor conductor 307 has a wire length of about 0.52 unit. The wire width of the seventh inductor conductor 307 is the same as that of the first inductor conductor 301.

In the thirteenth layer L13, a portion except the twenty-fifth electrode portion 513, the twenty-sixth electrode portion 613, and the seventh inductor conductor 307 is the thirteenth insulating portion 213. The thirteenth insulating portion 213 is configured of a nonmagnetic insulator made of the same material as that of the first insulating portion 201.

The fourteenth layer L14 is laminated onto the principal surface of the thirteenth layer L13 facing the first negative direction X2. When the fourteenth layer L14 is viewed in the first negative direction X2, similar to the first layer L1, the fourteenth layer L14 is rectangular. The fourteenth layer L14 is configured of a twenty-seventh electrode portion 514, a twenty-eighth electrode portion 614, a via conductor 407, and a fourteenth insulating portion 214.

The twenty-seventh electrode portion 514 is made of the same material as that of the first electrode portion 501. When the fourteenth layer L14 is viewed in the first negative direction X2, the twenty-seventh electrode portion 514 has the same dimension as the twenty-fifth electrode portion 513, and is located at the same position as the twenty-fifth electrode portion 513. Accordingly, the twenty-seventh electrode portion 514 is laminated onto the face of the twenty-fifth electrode portion 513 facing the first negative direction X2.

The twenty-eighth electrode portion 614 is made of the same material as that of the second electrode portion 601. When the fourteenth layer L14 is viewed in the first negative direction X2, the twenty-eighth electrode portion 614 has the same dimension as the twenty-sixth electrode portion 613, and is located at the same position as the twenty-sixth electrode portion 613. Accordingly, the twenty-eighth electrode portion 614 is laminated onto the face of the twenty-sixth electrode portion 613 facing the first negative direction X2.

The via conductor 407 is made of the same material as that of the first inductor conductor 301. The via conductor 407 is shaped like a cylinder extending along the first axis X. The via conductor 407 is laminated onto the face of the second end portion 307B of the seventh inductor conductor 307 facing the first negative direction X2. Thus, via conductor 407 is electrically connected to the second end portion 307B of the seventh inductor conductor 307. The via conductor 407 extends from the second end portion 307B of the seventh inductor conductor 307 in the first negative direction X2.

In the fourteenth layer L14, a portion except the twenty-seventh electrode portion 514, the twenty-eighth electrode portion 614, and the via conductor 407 is the fourteenth insulating portion 214. The fourteenth insulating portion 214 is configured of a nonmagnetic insulator made of the same material as that of the first insulating portion 201.

The fifteenth layer L15 is laminated onto the principal surface of the fourteenth layer L14 facing the first negative direction X2. When the fifteenth layer L15 is viewed in the first negative direction X2, similar to the first layer L1, the fifteenth layer L15 is rectangular. The fifteenth layer L15 is configured of a twenty-ninth electrode portion 515, a thirtieth electrode portion 615, an eighth inductor conductor 308, and a fifteenth insulating portion 215.

The twenty-ninth electrode portion 515 is made of the same material as that of the first electrode portion 501. When the fifteenth layer L15 is viewed in the first negative direction X2, the twenty-ninth electrode portion 515 has the same dimension as the twenty-seventh electrode portion 514, and is located at the same position as the twenty-seventh electrode portion 514. Accordingly, the twenty-ninth electrode portion 515 is laminated onto the face of the twenty-seventh electrode portion 514 facing the first negative direction X2.

The thirtieth electrode portion 615 is made of the same material as that of the second electrode portion 601. When the fifteenth layer L15 is viewed in the first negative direction X2, the thirtieth electrode portion 615 has the same dimension as the twenty-eighth electrode portion 614, and is located at the same position as the twenty-eighth electrode portion 614. Accordingly, the thirtieth electrode portion 615 is laminated onto the face of the twenty-eighth electrode portion 614 facing the first negative direction X2.

The eighth inductor conductor 308 is made of the same material as that of the first inductor conductor 301. When the fifteenth layer L15 is viewed in the first negative direction X2, eighth inductor conductor 308, as a whole, spirally extends substantially around the geometrical center of the fifteenth layer L15. A first end portion 308A of the eighth inductor conductor 308 is substantially circular. The first end portion 308A of the eighth inductor conductor 308 is located on the face of the via conductor 407 facing the first negative direction X2. Thus, the first end portion 308A of the eighth inductor conductor 308 is connected to the via conductor 407.

A second end portion 308B of the eighth inductor conductor 308 is substantially circular. When the fifteenth layer L15 is viewed in the first negative direction X2, the second end portion 308B is located at the same position as the second end portion 303B of the third inductor conductor 303. When the fifteenth layer L15 is viewed in the first negative direction X2, the eighth inductor conductor 308 extends clockwise from the first end portion 308A toward the second end portion 308B. In addition, the eighth inductor conductor 308 has the number of turns of about 1 turn. The eighth inductor conductor 308 has a wire length of 0.78 unit. The wire width of the eighth inductor conductor 308 is the same as that of the first inductor conductor 301.

In the fifteenth layer L15, a portion except the twenty-ninth electrode portion 515, the thirtieth electrode portion 615, and the eighth inductor conductor 308 is the fifteenth insulating portion 215. The fifteenth insulating portion 215 is configured of a nonmagnetic insulator made of the same material as that of the first insulating portion 201.

The sixteenth layer L16 is laminated onto the principal surface of the fifteenth layer L15 facing the first negative direction X2. When the sixteenth layer L16 is viewed in the first negative direction X2, similar to the first layer L1, the sixteenth layer L16 is rectangular. The sixteenth layer L16 is configured of a thirty-first electrode portion 516, a thirty-second electrode portion 616, a via conductor 408, and a sixteenth insulating portion 216.

The thirty-first electrode portion 516 is made of the same material as that of the first electrode portion 501. When the sixteenth layer L16 is viewed in the first negative direction X2, the thirty-first electrode portion 516 has the same dimension as the twenty-ninth electrode portion 515, and is located at the same position as the twenty-ninth electrode portion 515. Accordingly, thirty-first electrode portion 516 is laminated onto the face of the twenty-ninth electrode portion 515 facing the first negative direction X2.

The thirty-second electrode portion 616 is made of the same material as that of the second electrode portion 601. When the sixteenth layer L16 is viewed in the first negative direction X2, the thirty-second electrode portion 616 has the same dimension as the thirtieth electrode portion 615, and is located at the same position as the thirtieth electrode portion 615. Accordingly, the thirty-second electrode portion 616 is laminated onto the face of the thirtieth electrode portion 615 facing the first negative direction X2.

The via conductor 408 is made of the same material as that of the first inductor conductor 301. The via conductor 408 is shaped like a cylinder extending along the first axis X. The via conductor 408 is laminated onto the face of the second end portion 308B of the eighth inductor conductor 308 facing the first negative direction X2. Thus, via conductor 408 is electrically connected to the second end portion 308B of the eighth inductor conductor 308. The via conductor 408 extends from the second end portion 308B of the eighth inductor conductor 308 in the first negative direction X2.

In the sixteenth layer L16, a portion except the thirty-first electrode portion 516, the thirty-second electrode portion 616, and the via conductor 408 is the sixteenth insulating portion 216. The sixteenth insulating portion 216 is configured of a nonmagnetic insulator made of the same material as that of the first insulating portion 201.

The seventeenth layer L17 is laminated onto the principal surface of the sixteenth layer L16 facing the first negative direction X2. When the seventeenth layer L17 is viewed in the first negative direction X2, similar to the first layer L1, the seventeenth layer L17 is rectangular. The seventeenth layer L17 is configured of a thirty-third electrode portion 517, a thirty-fourth electrode portion 617, a ninth inductor conductor 309, and a seventeenth insulating portion 217.

The thirty-third electrode portion 517 is made of the same material as that of the first electrode portion 501. When the seventeenth layer L17 is viewed in the first negative direction X2, the thirty-third electrode portion 517 has the same dimension as the thirty-first electrode portion 516, and is located at the same position as the thirty-first electrode portion 516. Accordingly, the thirty-third electrode portion 517 is laminated onto the face of the thirty-first electrode portion 516 facing the first negative direction X2.

The thirty-fourth electrode portion 617 is made of the same material as that of the second electrode portion 601. When the seventeenth layer L17 is viewed in the first negative direction X2, the thirty-fourth electrode portion 617 has the same dimension as the thirty-second electrode portion 616, and is located at the same position as the thirty-second electrode portion 616. Accordingly, the thirty-fourth electrode portion 617 is laminated onto the face of the thirty-second electrode portion 616 facing the first negative direction X2.

The ninth inductor conductor 309 is made of the same material as that of the first inductor conductor 301. When the seventeenth layer L17 is viewed in the first negative direction X2, ninth inductor conductor 309, as a whole, spirally extends substantially around the geometrical center of the ninth layer L9. A first end portion 309A of the ninth inductor conductor 309 is substantially circular. The first end portion 309A of the ninth inductor conductor 309 is located on the face of the via conductor 408 facing the first negative direction X2. Thus, the first end portion 309A of the ninth inductor conductor 309 is connected to the via conductor 408.

A second end portion 309B of the ninth inductor conductor 309 is substantially circular. When the seventeenth layer L17 is viewed in the first negative direction X2, the second end portion 309B is located at the same position as the second end portion 306B of the sixth inductor conductor 306. When the seventeenth layer L17 is viewed in the first negative direction X2, the ninth inductor conductor 309 extends clockwise from the first end portion 309A toward the second end portion 309B. In addition, the ninth inductor conductor 309 has the number of turns of about 1 turn. The ninth inductor conductor 309 has a wire length of 0.78 unit. The wire width of the ninth inductor conductor 309 is the same as that of the first inductor conductor 301.

In the seventeenth layer L17, a portion except the thirty-third electrode portion 517, the thirty-fourth electrode portion 617, and the ninth inductor conductor 309 is the seventeenth insulating portion 217. The seventeenth insulating portion 217 is configured of a nonmagnetic insulator made of the same material as that of the first insulating portion 201.

The eighteenth layer L18 is laminated onto the principal surface of the seventeenth layer L17 facing the first negative direction X2. When the eighteenth layer L18 is viewed in the first negative direction X2, similar to the first layer L1, the eighteenth layer L18 is rectangular. The eighteenth layer L18 is configured of a thirty-fifth electrode portion 518, a thirty-sixth electrode portion 618, a via conductor 409, and an eighteenth insulating portion 218.

The thirty-fifth electrode portion 518 is made of the same material as that of the first electrode portion 501. When the eighteenth layer L18 is viewed in the first negative direction X2, the thirty-fifth electrode portion 518 has the same dimension as the thirty-third electrode portion 517, and is located at the same position as the thirty-third electrode portion 517. Accordingly, the thirty-fifth electrode portion 518 is laminated onto the face of the thirty-third electrode portion 517 facing the first negative direction X2.

The thirty-sixth electrode portion 618 is made of the same material as that of the second electrode portion 601. When the eighteenth layer L18 is viewed in the first negative direction X2, the thirty-sixth electrode portion 618 has the same dimension as the thirty-fourth electrode portion 617, and is located at the same position as the thirty-fourth electrode portion 617. Accordingly, the thirty-sixth electrode portion 618 is laminated onto the face of the thirty-fourth electrode portion 617 facing the first negative direction X2.

The via conductor 409 is made of the same material as that of the first inductor conductor 301. The via conductor 409 is shaped like a cylinder extending along the first axis X. The via conductor 409 is laminated onto the face of the second end portion 309B of the ninth inductor conductor 309 facing the first negative direction X2. Thus, the via conductor 409 is electrically connected to the second end portion 309B of the ninth inductor conductor 309. The via conductor 409 extends from the second end portion 309B of the ninth inductor conductor 309 in the first negative direction X2.

In the eighteenth layer L18, a portion except the thirty-fifth electrode portion 518, the thirty-sixth electrode portion 618, and the via conductor 409 is the eighteenth insulating portion 218. The eighteenth insulating portion 218 is configured of a nonmagnetic insulator made of the same material as that of the first insulating portion 201.

The nineteenth layer L19 is laminated onto the principal surface of the eighteenth layer L18 facing the first negative direction X2. When the nineteenth layer L19 is viewed in the first negative direction X2, similar to the first layer L1, the nineteenth layer L19 is rectangular. The nineteenth layer L19 is configured of a thirty-seventh electrode portion 519, a thirty-eighth electrode portion 619, a tenth inductor conductor 310, and a nineteenth insulating portion 219.

The thirty-seventh electrode portion 519 is made of the same material as that of the first electrode portion 501. When the nineteenth layer L19 is viewed in the first negative direction X2, the thirty-seventh electrode portion 519 has the same dimension as the thirty-fifth electrode portion 518, and is located at the same position as the thirty-fifth electrode portion 518. Accordingly, the thirty-seventh electrode portion 519 is laminated onto the face of the thirty-fifth electrode portion 518 facing the first negative direction X2.

The thirty-eighth electrode portion 619 is made of the same material as that of the second electrode portion 601. When the nineteenth layer L19 is viewed in the first negative direction X2, the thirty-eighth electrode portion 619 has the same dimension as the thirty-sixth electrode portion 618, and is located at the same position as the thirty-sixth electrode portion 618. Accordingly, the thirty-eighth electrode portion 619 is laminated onto the face of the thirty-sixth electrode portion 618 facing the first negative direction X2.

The tenth inductor conductor 310 is made of the same material as that of the first inductor conductor 301. When the nineteenth layer L19 is viewed in the first negative direction X2, the shape and arrangement of the tenth inductor conductor 310 is the same as that of the seventh inductor conductor 307. The tenth inductor conductor 310 extends clockwise from a first end portion 310A toward a second end portion 310B. In addition, the tenth inductor conductor 310 has the number of turns of about 0.5 turn. The tenth inductor conductor 310 has a wire length of about 0.52 unit. In addition, the wire width of the tenth inductor conductor 310 is the same as that of the first inductor conductor 301.

In the nineteenth layer L19, a portion except the thirty-seventh electrode portion 519, the thirty-eighth electrode portion 619, and the fifth inductor conductor 305 is the nineteenth insulating portion 219. The nineteenth insulating portion 219 is configured of an insulator made of the same material as that of the first insulating portion 201.

The twentieth layer L20 is laminated onto the principal surface of the nineteenth layer L19 facing the first negative direction X2. When the twentieth layer L20 is viewed in the first negative direction X2, similar to the first layer L1, the twentieth layer L20 is rectangular. The twentieth layer L20 is configured of a thirty-ninth electrode portion 520, a fortieth electrode portion 620, a via conductor 410, and a twentieth insulating portion 220.

The thirty-ninth electrode portion 520 is made of the same material as that of the first electrode portion 501. When the twentieth layer L20 is viewed in the first negative direction X2, the thirty-ninth electrode portion 520 has the same dimension as the thirty-seventh electrode portion 519, and is located at the same position as the thirty-seventh electrode portion 519. Accordingly, thirty-ninth electrode portion 520 is laminated onto the face of the thirty-seventh electrode portion 519 facing the first negative direction X2.

The fortieth electrode portion 620 is made of the same material as that of the second electrode portion 601. When the twentieth layer L20 is viewed in the first negative direction X2, the fortieth electrode portion 620 has the same dimension as the thirty-eighth electrode portion 619, and is located at the same position as the thirty-eighth electrode portion 619. Accordingly, the fortieth electrode portion 620 is laminated onto the face of the thirty-eighth electrode portion 619 facing the first negative direction X2.

The via conductor 410 is made of the same material as that of the first inductor conductor 301. The shape and arrangement of the via conductor 410 is the same as that of the via conductor 407.

In the twentieth layer L20, a portion except the thirty-ninth electrode portion 520, the fortieth electrode portion 620, and the via conductor 410 is the twentieth insulating portion 220. The twentieth insulating portion 220 is configured of a nonmagnetic insulator made of the same material as that of the first insulating portion 201.

The twenty-first layer L21 is laminated onto the principal surface of the twentieth layer L20 facing the first negative direction X2. When the twenty-first layer L21 is viewed in the first negative direction X2, similar to the first layer L1, the twenty-first layer L21 is rectangular. The twenty-first layer L21 is configured of a forty-first electrode portion 521, a forty-second electrode portion 621, an eleventh inductor conductor 311, and a twenty-first insulating portion 221.

The forty-first electrode portion 521 is made of the same material as that of the first electrode portion 501. When the twenty-first layer L21 is viewed in the first negative direction X2, the forty-first electrode portion 521 has the same dimension as the thirty-ninth electrode portion 520, and is located at the same position as the thirty-ninth electrode portion 520. Accordingly, the forty-first electrode portion 521 is laminated onto the face of the thirty-ninth electrode portion 520 facing the first negative direction X2.

The forty-second electrode portion 621 is made of the same material as that of the second electrode portion 601. When the twenty-first layer L21 is viewed in the first negative direction X2, the forty-second electrode portion 621 has the same dimension as the fortieth electrode portion 620, and is located at the same position as the fortieth electrode portion 620. Accordingly, the forty-second electrode portion 621 is laminated onto the face of the fortieth electrode portion 620 facing the first negative direction X2.

The eleventh inductor conductor 311 is made of the same material as that of the first inductor conductor 301. When the twenty-first layer L21 is viewed in the first negative direction X2, the eleventh inductor conductor 311, as a whole, spirally extends substantially around the geometrical center of the twenty-first layer L21. A first end portion 311A of the eleventh inductor conductor 311 is substantially circular. The first end portion 311A of the eleventh inductor conductor 311 is located on the face of the via conductor 410 facing the first negative direction X2. Thus, the first end portion 311A of the eleventh inductor conductor 311 is connected to the via conductor 410.

A second end portion 311B of the eleventh inductor conductor 311 is substantially circular. When the twenty-first layer L21 is viewed in the first negative direction X2, a position of the second end portion 311B of the eleventh inductor conductor 311 in the direction along the second axis Y is substantially the geometrical center of the twenty-first layer L21. A position of the second end portion 311B of the eleventh inductor conductor 311 in the direction along the third axis Z is located on the side of the third positive direction Z1 relative to the geometrical center of the twenty-first layer L21. When the twenty-first layer L21 is viewed in the first negative direction X2, the eleventh inductor conductor 311 extends clockwise from the first end portion 311A toward the second end portion 311B. In addition, the eleventh inductor conductor 311 has the number of turns of about 0.5 turn. The eleventh inductor conductor 311 has a wire length of about 0.52 unit. The wire width of the eleventh inductor conductor 311 is the same as that of the first inductor conductor 301.

In the twenty-first L21, a portion except the forty-first electrode portion 521, the forty-second electrode portion 621, and the eleventh inductor conductor 311 is the twenty-first insulating portion 221. The twenty-first insulating portion 221 is configured of an insulator made of the same material as that of the first insulating portion 201.

The twenty-second layer L22 is laminated onto the principal surface of the twenty-first layer L21 facing the first negative direction X2. When the twenty-second layer L22 is viewed in the first negative direction X2, similar to the first layer L1, the twenty-second layer L22 is rectangular. The twenty-second layer L22 is configured of a forty-third electrode portion 522, a forty-fourth electrode portion 622, a via conductor 411, and a twenty-second insulating portion 222.

The forty-third electrode portion 522 is made of the same material as that of the first electrode portion 501. When the twenty-second layer L22 is viewed in the first negative direction X2, the forty-third electrode portion 522 has the same dimension as the forty-first electrode portion 521, and is located at the same position as the forty-first electrode portion 521. Accordingly, the forty-third electrode portion 522 is laminated onto the face of the forty-first electrode portion 521 facing the first negative direction X2.

The forty-fourth electrode portion 622 is made of the same material as that of the second electrode portion 601. When the twenty-second layer L22 is viewed in the first negative direction X2, the forty-fourth electrode portion 622 has the same dimension as the forty-second electrode portion 621, and is located at the same position as the forty-second electrode portion 621. Accordingly, the forty-fourth electrode portion 622 is laminated onto the face of the forty-second electrode portion 621 facing the first negative direction X2.

The via conductor 411 is made of the same material as that of the first inductor conductor 301. The via conductor 411 is shaped like a cylinder extending along the first axis X. The via conductor 411 is laminated onto the face of the second end portion 311B of the eleventh inductor conductor 311 facing the first negative direction X2. Thus, the via conductor 411 is electrically connected to the second end portion 311B of the eleventh inductor conductor 311. The via conductor 411 extends from the second end portion 311B of the eleventh inductor conductor 311 in the first negative direction X2.

In the twenty-second layer L22, a portion except the forty-third electrode portion 522, the forty-fourth electrode portion 622, and the via conductor 411 is the twenty-second insulating portion 222. The twenty-second insulating portion 222 is configured of a nonmagnetic insulator made of the same material as that of the first insulating portion 201.

The twenty-third layer L23 is laminated onto the principal surface of the twenty-second layer L22 facing the first negative direction X2. When the twenty-third layer L23 is viewed in the first negative direction X2, similar to the first layer L1, the twenty-third layer L23 is rectangular. The twenty-third layer L23 is configured of a forty-fifth electrode portion 523, a forty-sixth electrode portion 623, a twelfth inductor conductor 312, and a twenty-third insulating portion 223.

The forty-fifth electrode portion 523 is made of the same material as that of the first electrode portion 501. When the twenty-third layer L23 is viewed in the first negative direction X2, the forty-fifth electrode portion 523 has the same dimension as the forty-third electrode portion 522, and is located at the same position as the forty-third electrode portion 522. Accordingly, the forty-fifth electrode portion 523 is laminated onto the face of the forty-third electrode portion 522 facing the first negative direction X2.

The forty-sixth electrode portion 623 is made of the same material as that of the second electrode portion 601. When the twenty-third layer L23 is viewed in the first negative direction X2, the forty-sixth electrode portion 623 has the same dimension as the forty-fourth electrode portion 622, and is located at the same position as the forty-fourth electrode portion 622. Accordingly, the forty-sixth electrode portion 623 is laminated onto the face of the forty-fourth electrode portion 622 facing the first negative direction X2.

The twelfth inductor conductor 312 is made of the same material as that of the first inductor conductor 301. When the twenty-third layer L23 is viewed in the first negative direction X2, twelfth inductor conductor 312, as a whole, spirally extends substantially around the geometrical center of the twenty-third layer L23. A first end portion 312A of the twelfth inductor conductor 312 is substantially circular. The first end portion 312A of the twelfth inductor conductor 312 is located on the face of the via conductor 411 facing the first negative direction X2. Thus, the first end portion 312A of the twelfth inductor conductor 312 is connected to the via conductor 411.

A second end portion 312B of the twelfth inductor conductor 312 is a portion offset from a circling path configured by overlapping the inductor conductors 30 in the first layer L1 to the twenty-third layer L23 when viewed in the first negative direction X2. The second end portion 312B is connected to an end portion of the forty-sixth electrode portion 623 on the side of the third negative direction Z2 in the direction along the third axis Z. When the twenty-third layer L23 is viewed in the first negative direction X2, the twelfth inductor conductor 312 extends clockwise from the first end portion 312A toward the second end portion 312B. It is noted that the second end portion 312B of the twelfth inductor conductor 312 is a second end portion of the entire inductor wire 12. In addition, the twelfth inductor conductor 312 has the number of turns of about 0.5 turns. The twelfth inductor conductor 312 that does not include the second end portion 312B and includes the first end portion 312A has a wire length of 0.52 units. The wire width of the twelfth inductor conductor 312 is the same as that of the first inductor conductor 301.

In the twenty-third layer L23, a portion except the forty-fifth electrode portion 523, the forty-sixth electrode portion 623, and the twelfth inductor conductor 312 is the twenty-third insulating portion 223. The twenty-third insulating portion 223 is configured of a nonmagnetic insulator made of the same material as that of the first insulating portion 201.

The element body 11 includes a first coating insulating layer 71 and a second coating insulating layer 72. The first coating insulating layer 71 is laminated onto the principal surface of the first layer L1 facing the first positive direction X1. When the first coating insulating layer 71 is viewed in the first negative direction X2, similar to the first layer L1, the first coating insulating layer 71 is rectangular. The first coating insulating layer 71 is configured of a nonmagnetic insulator made of the same material as that of the first insulating portion 201.

The second coating insulating layer 72 is laminated onto the principal surface of the twenty-third layer L23 facing the first negative direction X2. When the second coating insulating layer 72 is viewed in the first negative direction X2, similar to the first layer L1, the second coating insulating layer 72 is rectangular.

The second coating insulating layer 72 has a forty-seventh electrode portion 524, a forty-eighth electrode portion 624, and a twenty-fourth insulating portion 224.

The forty-seventh electrode portion 524 is made of the same material as that of the first electrode portion 501. The forty-seventh electrode portion 524 is exposed from the end surface of the second coating insulating layer 72 on the side of the second positive direction Y1 to the principal surface of the second coating insulating layer 72 on the side of the first negative direction X2. In addition, when viewed in the first negative direction X2, a part of the forty-seventh electrode portion 524 and the forty-fifth electrode portion 523 overlap. The part of the forty-seventh electrode portion 524 is connected to the forty-fifth electrode portion 523.

The forty-eighth electrode portion 624 is made of the same material as that of the second electrode portion 601. The forty-eighth electrode portion 624 is exposed from the end surface of the second coating insulating layer 72 on the side of the second negative direction Y2 to the principal surface of the second coating insulating layer 72 on the side of the first negative direction X2. In addition, when viewed in the first negative direction X2, a part of the forty-eighth electrode portion 624 and the forty-sixth electrode portion 623 overlap. The part of the forty-eighth electrode portion 624 is connected to the forty-sixth electrode portion 623.

The twenty-fourth insulating portion 224 is a portion of the second coating insulating layer 72 except the forty-seventh electrode portion 524 and the forty-eighth electrode portion 624. The twenty-fourth insulating portion 224 is configured of a nonmagnetic insulator made of the same material as that of the first insulating portion 201.

It is noted that the first coating insulating layer 71 may be configured by laminating a plurality of insulating layers. In addition, some of the insulating layers may be colored. This also applies to the second coating insulating layer 72.

The first insulating portion 201 to the twenty-fourth insulating portion 224 above described are integrated with the first coating insulating layer 71. Accordingly, a physical boundary between the first insulating portion 201 to the twenty-fourth insulating portion 224 and the first coating insulating layer 71 may be absent. Hereinafter, when it is no need to discriminate them, they are collectively referred to an insulating portion 20.

Each inductor conductor 30 and each via conductor 40 above described are alternately laminated in the direction along the first axis X. That is, the inductor conductors 30 are spaced along the first axis X. Each via conductor 40 interconnects the adjacent inductor conductors 30 in the direction along the first axis X.

The inductor wire 12 is integrated. That is, the first inductor conductor 301 to the twelfth inductor conductor 312, and the via conductor 401 to the via conductor 411 are integrated. Accordingly, their physical boundaries may be absent. The inductor wire 12 are spirally wound as a whole. The center axis for winding of the inductor wire 12 is the axis along the first axis X.

Further, the first electrode portion 501 to the forty-seventh electrode portion 524 above described are integrated. These electrodes are combined to form the first electrode 50. Similarly, the second electrode portion 601 to the forty-eighth electrode portion 624 above described are integrated. These electrodes are combined to form the second electrode 60.

In this embodiment, the element body 11 of the multilayer inductor component 10 is configured of the insulating portion 20, the first electrode 50, and the second electrode 60. It is noted that the element body 11 is fired. The inductor wire 12 extends within the element body 11. The inductor wire 12, the first electrode 50, and the second electrode 60 may be integrated. Accordingly, there may be no boundary between the inductor wire 12 and the first electrode 50, and between the inductor wire 12 and the second electrode 60.

When the first layer L1 to the twenty-third layer L23, the first coating insulating layer 71, and the second coating insulating layer 72 are laminated, as illustrated in FIG. 1, the element body 11 is shaped like a rectangular parallelepiped as a whole. It is noted that the first electrode 50 is exposed to the outside of the element body 11 in a region from the first end surface 11E to the bottom surface 11A. In addition, the second electrode 60 is exposed to the outside of the element body 11 in a region from the second end surface 11F to the bottom surface 11A. That is, the first electrode 50 and the second electrode 60 are not exposed to the outside of the element body 11 on the top surface 11B.

As illustrated in FIG. 1, the multilayer inductor component 10 includes a first coating electrode 81 and a second coating electrode 82. The first coating electrode 81 covers the face of the first electrode 50, which is exposed to the outside of the element body 11. Although not illustrated, the first coating electrode 81 has a two-layered configuration of nickel plating and tin plating. It is noted that the portion of the first electrode 50, which is exposed to the outside of the element body 11, refers to the portion of the first electrode 50, which is not covered with the element body 11. Accordingly, even when covered with any other layer, the first electrode 50 can be said to be exposed to the outside of the element body 11.

The second coating electrode 82 covers the face of the second electrode 60, which is exposed to the outside of the element body 11. Although not illustrated, the second coating electrode 82 has a two-layered configuration of nickel plating and tin plating. It is noted that, in FIG. 2, the first coating electrode 81 and the second coating electrode 82 are omitted.

Conductor Area

Here, when viewed in the direction along the first axis X, the area of each inductor conductor 30 is defined as a conductor area. In addition, in this embodiment, the inductor wire 12 has the twelve inductor conductors 30. Further, in the directions along the first axis X, the conductor areas of the inductor conductor 30 closest to the top surface 11B to the sixth inductor conductor 30 are defined as a top surface-side conductor area TA. Specifically, a sum of the conductor areas of the first inductor conductor 301, the second inductor conductor 302, the third inductor conductor 303, the fourth inductor conductor 304, the fifth inductor conductor 305, and the sixth inductor conductor 306 is the top surface-side conductor area TA. On the other hand, in the direction along the first axis X, the conductor areas of the inductor conductor 30 closest to the bottom surface 11A to the sixth inductor conductor 30 is defined as a bottom surface-side conductor area BA. Specifically, a sum of the conductor areas of the seventh inductor conductor 307, the eighth inductor conductor 308, the ninth inductor conductor 309, the tenth inductor conductor 310, the eleventh inductor conductor 311, and the twelfth inductor conductor 312 is the bottom surface-side conductor area BA. Here, the top surface-side conductor area TA is 1.1 times or more of the bottom surface-side conductor area BA. In addition, the top surface-side conductor area TA is twice or less of the bottom surface-side conductor area BA.

It is noted that the area of the inductor conductor 30 is measured as follows. First, the element body 11 is polished so as to expose the first layer L1. Then, using an image analysis software, the conductor area of the cross section of the first inductor conductor 301 is measured. Next, the element body 11 is polished so as to expose the second layer L2. Similarly, using the image analysis software, the conductor area of the second inductor conductor 302 is measured. The step is repeated to measure the conductor area of each inductor conductor 30. However, the conductor area of the first inductor conductor 301 includes the area of the second end portion 301B and does not include the area of the first end portion 301A. In addition, the conductor area of the twelfth inductor conductor 312 includes the area of the first end portion 312A, and does not include the area of the second end portion 312B. On the other hand, the conductor area of the second inductor conductor 302 includes the area of the first end portion 302A and the second end portion 302B. This also applies to the conductor areas of the third inductor conductor 303 to the eleventh inductor conductor 311. That is, the conductor area is measured as the area of the portion where the inductor conductors 30 overlap in perspective view in the first negative direction X2.

As described above, the inductor conductors 30 have a uniform wire width. Accordingly, the ratio of the conductor area is substantially equal to the ratio of the wire length. In the direction along the first axis X, a sum of the wire lengths of the inductor conductor 30 closest to the top surface 11B to the sixth inductor conductor 30 is about 6.09 units. In addition, in the direction along the first axis X, a sum of the wire lengths of the inductor conductor 30 closest to the bottom surface 11A to the sixth inductor conductor 30 is about 3.65 units. Accordingly, specifically, the top surface-side conductor area TA is 1.67 times of the bottom surface-side conductor area BA. It is noted that the conductor area ratio may be unequal to the wire length ratio depending on the dimension of the second end portion 301B of the first inductor conductor 301 and each substantially circular end portion.

As described above, among the inductor conductors 30, the second inductor conductor 302 and the fourth inductor conductor 304 have the longest wire length. Accordingly, the inductor conductors 30 having the largest conductor area are the above-described two inductor conductors 30. In other words, the inductor conductors 30 having the largest conductor area are included in the inductor conductor 30 closest to the top surface 11B to the sixth inductor conductor 30 in the direction along the first axis X.

In addition, as described above, among the inductor conductors 30, the seventh inductor conductor 307, the tenth inductor conductor 310, the eleventh inductor conductor 311, and the twelfth inductor conductor 312 have the shortest wire length. Accordingly, the inductor conductors 30 having the smallest conductor area are the seventh inductor conductor 307, the tenth inductor conductor 310, the eleventh inductor conductor 311, and the twelfth inductor conductor 312. In other words, the inductor conductors 30 having the smallest conductor area are included in the inductor conductor 30 closest to the bottom surface 11A to the sixth inductor conductor 30 in the direction along the first axis X.

The twelfth inductor conductor 312 is one of the inductor conductors 30 having the smallest conductor area. That is, among the conductor areas of the plurality of inductor conductors 30, the conductor area of the inductor conductor 30 closest to the bottom surface 11A in the direction along the first axis X is the smallest.

The largest conductor area of the inductor conductor 30 is 1.3 times or more and 2.1 times or less (i.e., from 1.3 times to 2.1 times) of the smallest conductor area. Specifically, the inductor conductors 30 having the largest conductor area, which are the second inductor conductor 302 and the fourth inductor conductor 304, have a wire length of about 1.04 units. The inductor conductors 30 having the smallest conductor area, which are the seventh inductor conductor 307, the tenth inductor conductor 310, the eleventh inductor conductor 311, and the twelfth inductor conductor 312, have a wire length of 0.52 units. Accordingly, the largest conductor area of the inductor conductors 30 is about twice of the smallest conductor area.

Multilayer Inductor Component in Comparative Example

Next, a multilayer inductor component 10 in a comparative example will be described.

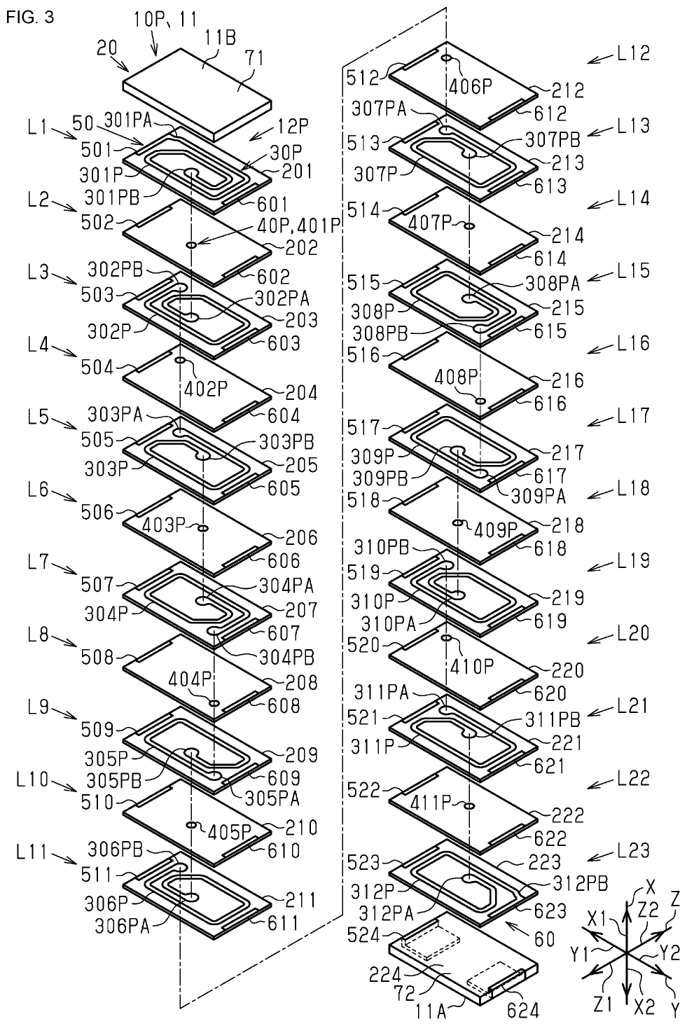

As illustrated in FIG. 3, the multilayer inductor component 10P includes an inductor wire 12P. The inductor wire 12P has twelve inductor conductors 30P and eleven via conductors 40P. In the multilayer inductor component 10P, as in the above-described embodiment, a layer having the inductor conductor 30P and a layer having the via conductor 40P are alternately laminated. It is noted that the multilayer inductor component 10P in the comparative example and the above-described multilayer inductor component 10 have common components except the inductor conductors 30P. Accordingly, the common components of the multilayer inductor component 10P in the comparative example and the above-described multilayer inductor component 10 are given the same reference numerals and description thereof is omitted. In addition, the total number of turns of the inductor conductors of the multilayer inductor component 10 is equal to that of the multilayer inductor component 10P in the comparative example. Hereinafter, only the inductor conductors 30P will be described.

When the first layer L1 is viewed in the first negative direction X2, the shape and arrangement of a first inductor conductor 301P is that of the first inductor conductor 301 in the above-described embodiment. Accordingly, the first inductor conductor 301P has the number of turns of about 1.5 turns.

When the third layer L3 is viewed in the first negative direction X2, a second inductor conductor 302P extends clockwise from a first end portion 302PA toward a second end portion 302PB. The second inductor conductor 302P has the number of turns of about 1.25 turns. Here, the wire length of the first inductor conductor 301P that does not include a first end portion 301PA and includes a second end portion 301PB is defined as 1 unit. In this case, the second inductor conductor 302P has a wire length of about 0.83 units.

When the fifth layer L5 is viewed in the first negative direction X2, a third inductor conductor 303P extends clockwise from a first end portion 303PA toward a second end portion 303PB. The third inductor conductor 303P has the number of turns of about 1 turn. The third inductor conductor 303P has a wire length of about 0.78 units.

When the seventh layer L7 is viewed in the first negative direction X2, the shape and arrangement of a fourth inductor conductor 304P is two-fold symmetry of the second inductor conductor 302P. Accordingly, the fourth inductor conductor 304P has the number of turns of about 1.25 turns. In addition, the fourth inductor conductor 304P has a wire length of about 0.83 units.

When the ninth layer L9 is viewed in the first negative direction X2, the shape and arrangement of a fifth inductor conductor 305P is two-fold symmetry of the third inductor conductor 303P. Accordingly, the fifth inductor conductor 305P has the number of turns of about 1 turn. In addition, the fifth inductor conductor 305P has a wire length of about 0.78 units.

When the eleventh layer L11 is viewed in the first negative direction X2, the shape and arrangement of a sixth inductor conductor 306P is that of the second inductor conductor 302P. Accordingly, the sixth inductor conductor 306P has the number of turns of about 1.25 turns. In addition, the sixth inductor conductor 306P has a wire length of about 0.83 units.

When the thirteenth layer L13 is viewed in the first negative direction X2, the shape and arrangement of a seventh inductor conductor 307P is the same as that of the third inductor conductor 303P. Accordingly, the seventh inductor conductor 307P has the number of turns of about 1 turn. In addition, the fifth inductor conductor 305P has a wire length of about 0.78 unit.

When the fifteenth layer L15 is viewed in the first negative direction X2, the shape and arrangement of an eighth inductor conductor 308P is the same as that of the fourth inductor conductor 304P. Accordingly, the eighth inductor conductor 308P has the number of turns of about 1.25 turns. In addition, the eighth inductor conductor 308P has a wire length of about 0.83 units.

When the seventeenth layer L17 is viewed in the first negative direction X2, the shape and arrangement of a ninth inductor conductor 309P is the same as that of the fifth inductor conductor 305P. Accordingly, the ninth inductor conductor 309P has the number of turns of about 1 turn. In addition, the ninth inductor conductor 309P has a wire length of about 0.78 units.

When the nineteenth layer L19 is viewed in the first negative direction X2, the shape and arrangement of a tenth inductor conductor 310P is the same as that of the sixth inductor conductor 306P. Accordingly, the tenth inductor conductor 310P has the number of turns of about 1.25 turns. In addition, the tenth inductor conductor 310P has a wire length of about 0.83 units.

When the twenty-first layer L21 is viewed in the first negative direction X2, the shape and arrangement of an eleventh inductor conductor 311P is the same as that of the seventh inductor conductor 307P. Accordingly, the eleventh inductor conductor 311P has the number of turns of about 1 turn. In addition, the eleventh inductor conductor 311P has a wire length of about 0.78 units.

When the twenty-third layer L23 is viewed in the first negative direction X2, a twelfth inductor conductor 312P extends clockwise from a first end portion 312PA toward a second end portion 312PB. The twelfth inductor conductor 312P has the number of turns of about 1 turn. The twelfth inductor conductor 312P has a wire length of about 0.78 units.

The wire width of each inductor conductor 30P of the multilayer inductor component 10P except the first end portion and the second end portion is uniform. Accordingly, the conductor area of each inductor conductor 30P is proportional to the wire length of each inductor conductor 30P.

The top surface-side conductor area TA of the multilayer inductor component 10P in the above-described comparative example is about 1.05 times of the bottom surface-side conductor area BA. That is, the top surface-side conductor area TA is less than 1.1 times of the bottom surface-side conductor area BA.

Simulation

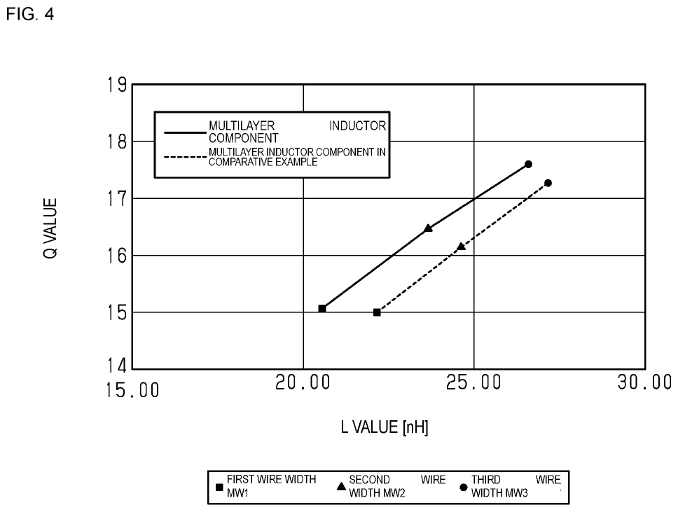

As illustrated in FIG. 4, inductance values and Q values are simulated when a certain voltage is applied to the multilayer inductor component 10 and the multilayer inductor component 10P in the comparative example. In the simulation, in the multilayer inductor component 10 and the multilayer inductor component 10P in the comparative example, the wire width of each inductor conductor is varied. Specifically, the wire widths in the simulation are a first wire width MW1, a second wire width MW2, and a third wire width MW3. The second wire width MW2 is smaller than the first wire width MW1. The third wire width MW3 is smaller than the second wire width MW2. In addition, the frequency of AC voltage at the first wire width MW11 to the third wire width MW3 is set as 500 MHz. In FIG. 4, test results of the first wire width MW1 are represented as squares, test results of the second wire width MW2 are represented as triangles, and test results of the third wire width MW3 are represented as circles.

In the first wire width MW1, the Q value of the multilayer inductor component 10 was slightly higher than the Q value of the multilayer inductor component 10P in the comparative example. In the second wire width MW2, the Q value of the multilayer inductor component 10 was higher than the Q value of the multilayer inductor component 10P in the comparative example. In the third wire width MW3, the Q value of the multilayer inductor component 10 was higher than the Q value of the multilayer inductor component 10P in the comparative example. That is, in any of the wire widths, the Q value of the multilayer inductor component 10 was higher than the Q value of the multilayer inductor component 10P in the comparative example.

Further, in any of the first wire width MW11 to the third wire width MW3, the inductance value of the multilayer inductor component 10 decreased as compared to the multilayer inductor component 10P in the comparative example. However, as the wire width was smaller, a decrease in the inductance value became smaller.

### Effects of this Embodiment

(1) In the above-described embodiment, the top surface-side conductor area TA is 1.1 times or more of the bottom surface-side conductor area BA. With such configuration, on the side close to the bottom surface 11A, the conductor areas of the inductor conductors 30 opposed to the first electrode 50 and the second electrode 60 can be reduced. This can reduce stray capacitance that occurs between each electrode and the inductor conductor 30. Accordingly, the Q value of the multilayer inductor component 10 can be enhanced.

With the above-described configuration, a sum of the top surface-side conductor area TA is larger than a sum of the bottom surface-side conductor area BA. That is, the conductor area of the inductor conductor 30 can be ensured at the place that hardly contributes to stray capacitance occurring between the inductor conductor 30 and each electrode. Accordingly, with the above-described configuration, a decrease in the inductance value of the multilayer inductor component 10 can be suppressed.

(2) As a difference between the sum of the bottom surface-side conductor area BA and the sum of the top surface-side conductor area TA is larger, an internal stress that occurs when the multilayer inductor component 10 is fired becomes larger. The internal stress can cause cracks or the like in the multilayer inductor component 10. In the above-described embodiment, the top surface-side conductor area TA is twice or less of the bottom surface-side conductor area BA. That is, with the above-described configuration, an increase in the internal stress of the multilayer inductor component 10 can be suppressed.

(3) It is assumed that in the multilayer inductor component 10, the inductor conductors 30 have different wire widths. For example, it is assumed that the wire widths of the seventh inductor conductor 307 to the twelfth inductor conductor 312 are smaller than the wire widths of the first inductor conductor 301 to the sixth inductor conductor 306. Due to the size of wire width, the sum of the top surface-side conductor area TA is assumed to be larger than the sum of the bottom surface-side conductor area BA.

In this case, the cross-sectional area of each of the seventh inductor conductor 307 to the twelfth inductor conductor 312, which is orthogonal to the extending direction of each inductor conductor 30, is smaller than the cross-sectional area of each of the first inductor conductor 301 to the sixth inductor conductor 306, which is orthogonal to the extending direction of each inductor conductor 30. When the cross-sectional area is small, a wire breaking risk is high due to heat caused at the use of the multilayer inductor component 10 and at firing.

In the above-described embodiment, the inductor conductors 30 have a uniform wire width. That is, the cross-sectional area of each inductor conductor 30, which is orthogonal to the extending direction of each inductor conductor 30, is uniform. As a result, with the above-described configuration, the above-mentioned wire breaking risk of the inductor conductor 30 can be lowered.

(4) In the above-described embodiment, the largest conductor area of the inductor conductor 30 is 1.3 times or more and 2.1 times or less (i.e., from 1.3 times to 2.1 times) of the smallest conductor area. Specifically, the largest conductor area of the inductor conductors 30 is about twice of the smallest conductor area. As mentioned above, a difference between the largest conductor area and the smallest conductor area of the inductor conductors 30 is not extreme. Thus, a large internal stress can be prevented from occurring a place between the inductor conductor 30 having the largest conductor area and the inductor conductor 30 having the smallest conductor area. From the viewpoint of improving the Q value, the largest conductor area of the inductor conductors 30 is preferably 1.3 times or more of the smallest conductor area.

(5) In the above-described embodiment, the inductor conductors 30 having the largest conductor area are the inductor conductor 30 closest to the top surface 11B to the sixth inductor conductor 30 in the direction along the first axis X. That is, the inductor conductors 30 having a large conductor area are disposed on the side away from the bottom surface 11A. With this configuration, a stray capacitance occurring between each electrode and the inductor conductor 30 can be suppressed more effectively.

(6) In the above-described embodiment, the length of the long side of the bottom surface 11A is 0.4 mm. The length of the short side of the bottom surface 11A is 0.2 mm. Thus, in the small-sized multilayer inductor component 10, the distance between each electrode and the inductor conductor 30 tends to be small. That is, in such small-sized multilayer inductor component 10, a stray capacitance tends to be large. Accordingly, it is particularly suitable to apply the above-described conductor area to such small-sized multilayer inductor component 10.

(7) When each electrode is also located on the side of the top surface 11B, a stray capacitance occurs between the electrode on the side of the top surface 11B and the inductor conductor 30. In the above-described embodiment, each electrode on the top surface 11B is not exposed to the outside of the element body 11. In the above-described embodiment, such stray capacitance can be prevented from occurring.

(8) In the above-described embodiment, the bottom surface-side conductor area BA is smaller than the top surface-side conductor area TA. With such configuration, as compared to the configuration where the bottom surface-side conductor area BA is about the same as the top surface-side conductor area TA, the volume ratio of the insulating portion 20 in the element body 11 becomes large on the side close to the bottom surface 11A. In addition, the material of the insulating portion 20 has a higher strength than the material of the inductor conductor 30. For this reason, in the above-described embodiment, when the multilayer inductor component 10 is mounted to a substrate or the like, even if the element body 11 hits against the substrate or the like, chips or cracks are hard to occur in the element body 11.

(9) In the above-described embodiment, the inductor conductor 30 having the smallest conductor area is the inductor conductor 30 closest to the bottom surface 11A. As long as the ratio of the top surface-side conductor area TA to the bottom surface-side conductor area BA is uniform, as the conductor area of the inductor conductor 30 closest to the bottom surface 11A is smaller, the Q value is improved.

Modifications

This embodiment may be modified and implemented in the following manner. This embodiment and following modifications may be combined so as not to cause technical contradiction.

The element body 11 may be a rectangular parallelepiped that is longer in the direction along the first axis X, or a rectangular parallelepiped that is longer in the direction along the third axis Z.

The element body 11 may be shaped as a rectangular parallelepiped of the same size in the direction along the first axis X, in the dimension along the second axis Y, and in the direction along the third axis Z. That is, the lengths of the long side and the short side of the bottom surface 11A are not limited to the lengths in the above-described embodiment. To obtain the effect described in (6), it is preferred that the length of the long side of the bottom surface 11A is 0.63 mm or less, and the length of the short side of the bottom surface 11A is 0.33 mm or less.

The material of the insulating portion 20 is not limited to the example in the above-described embodiment as long as it is an insulator. For example, the material of the insulating portion 20 may be nonmagnetic insulator. In addition, a part of the insulating portion 20 may be nonmagnetic or magnetic insulator and different from remaining parts.

As long as the first electrode 50 and the second electrode 60 are exposed on the bottom surface 11A the to the outside of element body 11, their shape and arrangement is not specifically limited. For example, the first electrode 50 may be a five-face electrode that covers five faces of the element body 11 except the second end surface 11F. Further, the first electrode 50 may be exposed only on the bottom surface 11A. This also applies to the second electrode 60.

The first coating electrode 81 and the second coating electrode 82 may be configured in three or more layers. In addition, the material of each layer of the first coating electrode 81 and the second coating electrode 82 may be any conductive material. Further, the first coating electrode 81 and the second coating electrode 82 may be omitted.

As long as the top surface-side conductor area TA is 1.1 times or more of the bottom surface-side conductor area BA, the inductor conductor 30 may have different wire widths. Further, the first layer L1 to the twenty-third layer L23 may have different thicknesses. That is, the inductor conductors 30 may have different thicknesses.

The number of the inductor conductors 30 may be larger or smaller than the number in the above-described embodiment. Given that the number of the inductor conductors 30 is N, the sum of the conductor areas of the inductor conductor 30 closest to the top surface 11B to N/2th (round down a decimal point) inductor conductor 30 is defined as the top surface-side conductor area TA. In addition, the sum of the conductor areas of the inductor conductor 30 closest to the bottom surface 11A to the N/2th (round down a decimal point) inductor conductor 30 is defined as the bottom surface-side conductor area BA. That is, when the number of the inductor conductor 30 is an odd number, the conductor area of the central inductor conductor 30 in the direction along the first axis X does not belong to both the top surface-side conductor area TA and the bottom surface-side conductor area BA.

As the top surface-side conductor area TA is 1.1 times or more of the bottom surface-side conductor area BA, the multiplying factor is not specifically limited. However, to obtain the effect described in (2), the top surface-side conductor area TA is preferably twice or less of the bottom surface-side conductor area BA.

The largest conductor area may be less than 1.3 times of the smallest conductor area. Further, to obtain the effect described in (2), the largest conductor area is preferably 2.1 times or less of the smallest conductor area.

The inductor conductor 30 having the smallest conductor area may be any of the inductor conductor 30 closest to the bottom surface 11A to the sixth inductor conductor 30 in the direction along the first axis X. In addition, the inductor conductor 30 having the largest conductor area may be any of the inductor conductor 30 closest to the top surface 11B to the sixth inductor conductor 30 in the direction along the first axis X.

Further, the inductor conductor 30 having the largest conductor area may be any of the inductor conductor 30 closest to the bottom surface 11A to the sixth inductor conductor 30 in the direction along the first axis X. Similarly, the inductor conductor 30 having the smallest conductor area may be any of the inductor conductor 30 closest to the top surface 11B to the sixth inductor conductor 30 in the direction along the first axis X. Also in these cases, as a whole, the top surface-side conductor area TA only needs to be 1.1 times or more of the bottom surface-side conductor area BA.

In the above-described embodiment, as long as the top surface-side conductor area TA is 1.1 times or more of the bottom surface-side conductor area BA, the inductor conductors 30 having a large conductor area do not have to be concentrated on the side close to the top surface 11B.

For example, it is assumed that the number of the inductor conductors 30 is N, and X and Y are different integers of 1 or more and less than N (i.e., from 1 to less than N). At this time, the Xth inductor conductor 30 from the conductor area of the inductor conductor 30 closest to the bottom surface 11A may be larger than the conductor area of the X+1th inductor conductor 30 from the inductor conductor 30 closest to the bottom surface 11A. In addition, the conductor area of the Yth inductor conductor 30 from the inductor conductor 30 closest to the bottom surface 11A may be smaller than the conductor area of the Y+1th inductor conductor 30 from the inductor conductors 30 closest to the bottom surface 11A. That is, one or more X and Y that satisfy the above-described relation may be present.

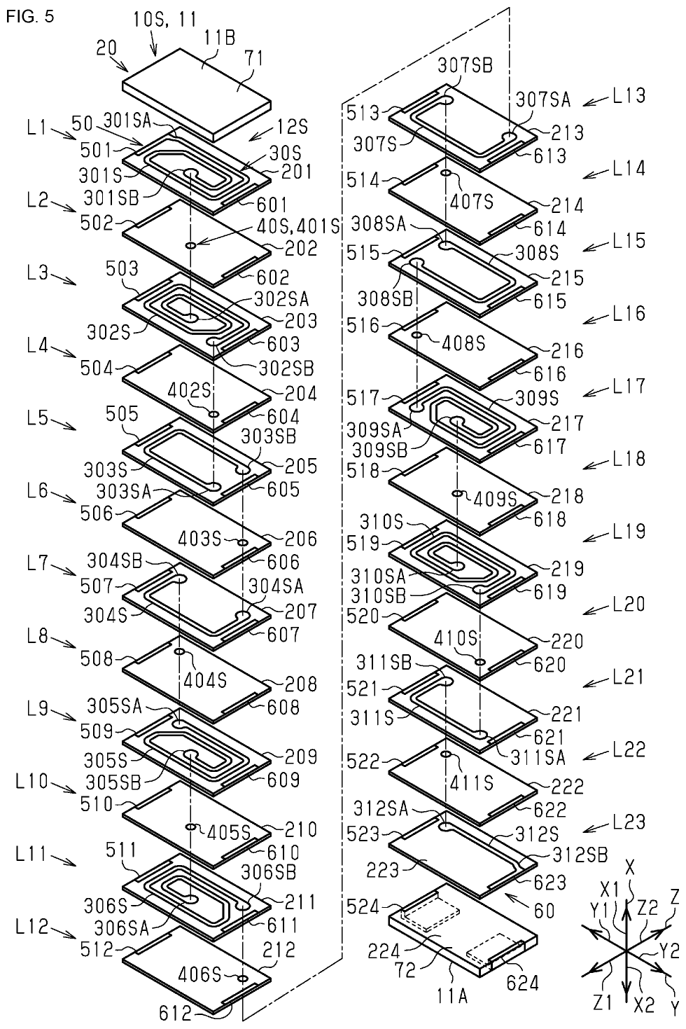

For example, a multilayer inductor component 10S illustrated in FIG. 5 includes an inductor wire 12S. The inductor wire 12S has twelve inductor conductors 30S and eleven via conductors 40S. As in the above-described embodiment, in the multilayer inductor component 10S, a layer having the inductor conductor 30S and a layer having the via conductor 40S are alternately laminated. It is noted that the multilayer inductor component 10S in FIG. 5 and the multilayer inductor component 10 in the above-described embodiment have common components except the inductor conductors 30S. Accordingly, the common components of the multilayer inductor component 10S in FIG. 5 and the multilayer inductor component 10 in the above-described embodiment are given the same reference numerals and description thereof is omitted. Hereinafter, only the inductor conductors 30S will be described.

When the first layer L1 is viewed in the first negative direction X2, the shape and arrangement of a first inductor conductor 301S is the same as that of the first inductor conductor 301 in the above-described embodiment. Accordingly, the first inductor conductor 301S has the number of turns of about 1.5 turns.

When the third layer L3 is viewed in the first negative direction X2, the shape and arrangement of a second inductor conductor 302S is the same as that of the second inductor conductor 302 in the above-described embodiment. Accordingly, the second inductor conductor 302S has the number of turns of about 1.75 turns. Here, the wire length of the first inductor conductor 301S that does not include a first end portion 301SA and includes a second end portion 301SB is defined as 1 unit. In this case, the second inductor conductor 302S has a wire length of about 1.04 turns.

When the fifth layer L5 is viewed in the first negative direction X2, a third inductor conductor 303S extends clockwise from a first end portion 303SA toward a second end portion 303SB. The third inductor conductor 303S has the number of turns of about 0.5 turns. The third inductor conductor 303S has a wire length of about 0.86 units.

When the seventh layer L7 is viewed in the first negative direction X2, the shape of a fourth inductor conductor 304S is the same as that of the seventh inductor conductor 307 in the above-described embodiment. Accordingly, the fourth inductor conductor 304S has the number of turns of about 0.5 turns. The fourth inductor conductor 304S has a wire length of about 0.52 units.

When the ninth layer L9 is viewed in the first negative direction X2, the shape of a fifth inductor conductor 305S is the same as that of the fifth inductor conductor 305 in the above-described embodiment. Accordingly, the fifth inductor conductor 305S has the number of turns of about 1.5 turns. The fifth inductor conductor 305S has a wire length of about 1 unit.

When the eleventh layer L11 is viewed in the first negative direction X2, the shape and arrangement of a sixth inductor conductor 306S is the same as that of the sixth inductor conductor 306 in the above-described embodiment. Accordingly, the sixth inductor conductor 306S has the number of turns of about 1.5 turns. The sixth inductor conductor 306S has a wire length of about 1 unit.

When the thirteenth layer L13 is viewed in the first negative direction X2, the shape and arrangement of a seventh inductor conductor 307S is the same as that of the seventh inductor conductor 307 in the above-described embodiment. The seventh inductor conductor 307S has the number of turns of about 0.5 turns. The seventh inductor conductor 307S has a wire length of about 0.52 units.

When the fifteenth layer L15 is viewed in the first negative direction X2, the shape and arrangement of an eighth inductor conductor 308S is the same as the third inductor conductor 303S inverted in the direction along the second axis Y The eighth inductor conductor 308S has the number of turns of about 0.5 turns. The eighth inductor conductor 308S has a wire length of about 0.86 units.

When the seventeenth layer L17 is viewed in the first negative direction X2, the shape and arrangement of a ninth inductor conductor 309S is the same as the second inductor conductor 302S inverted in the direction along the second axis Y Accordingly, the ninth inductor conductor 309S has the number of turns of about 1.75 turns. The ninth inductor conductor 309S has a wire length of about 1.04 units.

When the nineteenth layer L19 is viewed in the first negative direction X2, the shape and arrangement of a tenth inductor conductor 310S is the same as that of the second inductor conductor 302S. Accordingly, the tenth inductor conductor 310S has the number of turns of about 1.75 turns. The tenth inductor conductor 310S has a wire length of about 1.04 units.

When the twenty-first layer L21 is viewed in the first negative direction X2, an eleventh inductor conductor 311S extends clockwise from a first end portion 311SA toward a second end portion 311SB. The eleventh inductor conductor 311S has the number of turns of about 0.25 turns. The eleventh inductor conductor 311S has a wire length of about 0.39 units.

When the twenty-third layer L23 is viewed in the first negative direction X2, a twelfth inductor conductor 312S extends substantially parallel to the second axis Y The twelfth inductor conductor 312S has the number of turns of 0 turn. The twelfth inductor conductor 312S has a wire length of 0.26 units. That is, among the inductor conductors 30, the twelfth inductor conductor 312S has the shortest wire length.

The wire width of each inductor conductor 30S in the multilayer inductor component 10S is uniform except the first end portion and the second end portion. In the multilayer inductor component 10S in a modification example in FIG. 5, the top surface-side conductor area TA is about 1.32 times of the bottom surface-side conductor area BA. That is, the top surface-side conductor area TA is 1.1 times or more of the bottom surface-side conductor area BA.

In the modification example illustrated in FIG. 5, the conductor area of the fourth inductor conductors 30S from the inductor conductor 30S closest to the bottom surface 11A is larger than the conductor area of the fifth inductor conductor 30S from the inductor conductors 30S closest to the bottom surface 11A. In addition, the conductor area of the second inductor conductor 30S from the inductor conductor 30S closest to the bottom surface 11A is smaller than the conductor area of the third inductor conductor 30S from the inductor conductor 30S closest to the bottom surface 11A.

With the configuration of the example illustrated in FIG. 5, when sequentially viewed from the side close to the bottom surface 11A, portions having a large conductor area of two adjacent inductor conductors 30S and portions having a small conductor area of two adjacent inductor conductors 30S coexist. Specifically, the portion having a large conductor area and the portion having a small conductor area alternate for every two inductor conductors 30S. Since the portions having a large conductor area and the portions having a small conductor area coexist, a stress can be prevented from concentrating on a certain spot within the element body 11.

The technical concept that can be deducted from the above-described embodiment and modifications will be described below.

<1> A multilayer inductor component including a rectangular parallelepiped-shaped element body having six outer surfaces; and an inductor wire extending within the element body. The element body has an electrode connected to the inductor wire. Given that, among the six outer surfaces of the element body, a particular one surface is a bottom surface and a surface parallel to the bottom surface is a top surface, the electrode is exposed to outside of the element body on the bottom surface. The inductor wire has a plurality of inductor conductors extending parallel to the bottom surface and via conductors extending along an orthogonal axis orthogonal to the bottom surface. The inductor conductors are spaced along the orthogonal axis, and the via conductor interconnects the inductor conductors adjacent to each other in a direction along the orthogonal axis. Also, given that an area of each of the inductor conductors when viewed in the direction along the orthogonal axis is a conductor area, and the number of the inductor conductors is N, in the direction along the orthogonal axis, a top surface-side conductor area that is a sum of the conductor areas of the inductor conductor closest to the top surface to the N/2th (round down a decimal point) inductor conductor is 1.1 times or more of a bottom surface-side conductor area that is a sum of the conductor areas of the inductor conductor closest to the bottom surface to the N/2th (round down a decimal point) inductor conductor.

<2> The multilayer inductor component according to <1>, in which the top surface-side conductor area is twice or less of the bottom surface-side conductor area.

<3> The multilayer inductor component according to <1> or <2>, in which the inductor conductor having the largest conductor area is any of the inductor conductor closest to the top surface to the N/2th (round down a decimal point) inductor conductor in the direction along the orthogonal axis, and the inductor conductor having the smallest conductor area is any of the inductor conductor closest to the bottom surface to the N/2th (round down a decimal point) inductor conductor in the direction along the orthogonal axis.

<4> The multilayer inductor component according to <3>, in which the largest the conductor area is 1.3 times or more and 2.1 times or less (i.e., from 1.3 times to 2.1 times) of the smallest conductor area.

<5> The multilayer inductor component according to any one of <1> to <4>, in which among the conductor areas of the plurality of inductor conductors, the conductor area of the inductor conductor closest to the bottom surface in the direction along the orthogonal axis is the smallest.

<6> The multilayer inductor component according to any one of <1> to <5>, in which the inductor conductors have a uniform wire width.

<7> The multilayer inductor component according to any one of <1> to <6>, in which a length of a long side of the bottom surface is 0.63 mm or less, and a length of a short side of the bottom surface is 0.33 mm or less.

<8> The multilayer inductor component according to any one of <1> to <7>, in which the electrode is not exposed to the outside of the element body on the top surface.

<9> The multilayer inductor component according to any one of <1> to <8>, in which given that X and Y are different integers of 1 or more and less than N (i.e., from 1 to less than N), one or more pairs of X and Y that satisfy following requirements are present: the conductor area of the Xth inductor conductor from the inductor conductor closest to the bottom surface is larger than the conductor area of the X+1th inductor conductor from the inductor conductor closest to the bottom surface; and the conductor area of the Yth inductor conductor from the inductor conductor closest to the bottom surface is smaller than the conductor area of the Y+1th inductor conductor from the inductor conductor closest to the bottom surface.

What is claimed is:

1. A multilayer inductor component comprising:
a rectangular parallelepiped-shaped element body having six outer surfaces; and
an inductor wire extending within the element body, wherein
the element body has an electrode connected to the inductor wire,
given that, among the six outer surfaces of the element body, a particular one surface is a bottom surface and a surface parallel to the bottom surface is a top surface,
the electrode is exposed to outside of the element body on the bottom surface,
the inductor wire has a plurality of inductor conductors extending parallel to the bottom surface and via conductors extending along an orthogonal axis orthogonal to the bottom surface,
the inductor conductors are spaced along the orthogonal axis,
the via conductor interconnects the inductor conductors adjacent to each other in a direction along the orthogonal axis,
given that an area of each of the inductor conductors when viewed in the direction along the orthogonal axis is a conductor area, and a number of the inductor conductors is N,
in the direction along the orthogonal axis, a top surface-side conductor area that is a sum of the conductor areas of the inductor conductor closest to the top surface to the N/2th inductor conductor, rounded down a decimal point, is 1.1 times or more of a bottom surface-side conductor area that is a sum of the conductor areas of the inductor conductor closest to the bottom surface to the N/2th inductor conductor, rounded down a decimal point.

2. The multilayer inductor component according to claim 1, wherein
the top surface-side conductor area is twice or less of the bottom surface-side conductor area.

3. The multilayer inductor component according to claim 1, wherein
the inductor conductor having the largest conductor area is any of the inductor conductor closest to the top surface to the N/2th inductor conductor in the direction along the orthogonal axis, with N/2th being rounded down a decimal point, and
the inductor conductor having the smallest conductor area is any of the inductor conductor closest to the bottom surface to the N/2th inductor conductor in the direction along the orthogonal axis, with N/2th being rounded down a decimal point.

4. The multilayer inductor component according to claim 3, wherein
the largest conductor area is from 1.3 times to 2.1 times of the smallest conductor area.

5. The multilayer inductor component according to claim 1, wherein
among the conductor areas of the plurality of inductor conductors, the conductor area of the inductor conductor closest to the bottom surface in the direction along the orthogonal axis is the smallest.

6. The multilayer inductor component according to claim 1, wherein
the inductor conductors have a uniform wire width.

7. The multilayer inductor component according to claim 1, wherein
a length of a long side of the bottom surface is 0.63 mm or less, and
a length of a short side of the bottom surface is 0.33 mm or less.

8. The multilayer inductor component according to claim 1, wherein
the electrode is not exposed to the outside of the element body on the top surface.

9. The multilayer inductor component according to claim 1, wherein
given that X and Y are different integers of from 1 to less than N,
one or more pairs of X and Y that satisfy following requirements are present:
the conductor area of the Xth inductor conductor from the inductor conductor closest to the bottom surface is larger than the conductor area of the X+1th inductor conductor from the inductor conductor closest to the bottom surface; and
the conductor area of the Yth inductor conductor from the inductor conductor closest to the bottom surface is smaller than the conductor area of the Y+1th inductor conductor from the inductor conductor closest to the bottom surface.
